(19) United States
(12) Patent Application Publication
(10) Pub. No.: US 2025/0207357 A1
(43) Pub. Date: Jun. 26, 2025

(54) WORK MACHINE, OPERATION ASSISTING SYSTEM, INFORMATION PROCESSING DEVICE, AND PROGRAM

(71) Applicant: SUMITOMO HEAVY INDUSTRIES, LTD., Tokyo (JP)

(72) Inventor: Kosuke HARA, Kanagawa (JP)

(21) Appl. No.: 18/987,633

(22) Filed: Dec. 19, 2024

(30) Foreign Application Priority Data
Dec. 22, 2023 (JP) 2023-217118

(51) Int. Cl. E02F 9/20; E02F 9/26; G10L 15/22

(52) U.S. Cl. CPC E02F 9/2004; E02F 9/262; G10L 15/22; G10L 2015/223

(57) ABSTRACT

A work machine includes: an environment information acquiring part configured to acquire information about an environment surrounding the work machine; a verbalization part configured to verbalize the information acquired by the environment information acquiring part in natural language; a command acquiring part configured to acquire a command from an operator of the work machine in natural language; and a control part configured to control movement of the work machine based on interpretation of the command acquired by the command acquiring part and the information verbalized by the verbalization part, the interpretation being given by a predetermined language model.

### RELATED APPLICATION

The present application claims priority under 35 U.S.C. § 119 to Japanese Patent Application No. 2023-217118, filed Dec. 22, 2023, the entire contents of which are incorporated herein by reference.

### BACKGROUND

### 1. Technical Field

The present disclosure generally relates to work machines.

### 2. Description of Related Art

There are a variety of techniques for allowing, for example, a work machine to operate based on commands in natural language, such as voice/sound or text inputs.

For example, there is a related technique that, by employing speech recognition, allows a work machine to work in accordance with the speech recognition results of commands from the operator.

### SUMMARY

One embodiment of the present disclosure provides a work machine. This work machine includes:
an environment information acquiring part configured to acquire information about an environment surrounding the work machine;
a verbalization part configured to verbalize the information acquired by the environment information acquiring part in natural language;
a command acquiring part configured to acquire a command from an operator of the work machine in natural language; and
a control part configured to control movement of the work machine based on interpretation of the command acquired by the command acquiring part and the information verbalized by the verbalization part, the interpretation being given by a predetermined language model.

Also, another embodiment of the present disclosure provides an operation assisting system. This operation assisting system includes:
an environment information acquiring part configured to acquire information about an environment surrounding the work machine;
a verbalization part configured to verbalize the information acquired by the environment information acquiring part in natural language;
a command acquiring part configured to acquire a command from an operator of the work machine in natural language; and
a control part configured to control movement of the work machine based on interpretation of the command acquired by the command acquiring part and the information verbalized by the verbalization part, by a predetermined language model.

Yet another embodiment of the present disclosure provides an information processing device. This information processing device includes:
a verbalization part configured to verbalize information about an environment surrounding a work machine in natural language;
a command acquiring part configured to acquire a command from an operator of the work machine in natural language; and
a control part configured to control movement of the work machine based on interpretation of the command acquired by the command acquiring part and the information verbalized by the verbalization part, the interpretation being given by a predetermined language model.

Yet another embodiment of the present disclosure provides a recording medium. This recording medium stores instructions that, when executed by a computer, cause the computer to:
verbalize information about an environment surrounding a work machine in natural language;
acquire a command from an operator of the work machine in natural language; and
control movement of the work machine based on interpretation of the acquired command and the verbalized information, the interpretation being given by a predetermined language model.

According to the above-described embodiments, it is possible to improve the range of operations that a work machine is able to perform based on commands from the operator in natural language.

### BRIEF DESCRIPTION OF THE DRAWINGS

FIG. 1 is a side view showing an example of an excavator;

FIG. 2 is a top view showing an example of an excavator;

FIG. 3 is a diagram that shows an example structure relating to an excavator's remote operations;

FIG. 4 is a diagram that shows an example structure of an excavator;

FIG. 5 is a diagram showing an example hardware structure of a remote operation assisting device;

FIG. 6 is a functional block diagram showing a first example functional structure for assisting an excavator's operations;

FIG. 7 is a diagram showing an example surrounding environment of an excavator;

FIG. 8 is a diagram showing an example of an exercise assigned to a language model;

FIG. 9 is a diagram showing an example combination of a prompt and an output of a language model;

FIG. 10 is a flowchart showing an overview of a first example process for assisting an excavator's operations;

FIG. 11 is a functional block diagram showing a second example functional structure for assisting an excavator's operations;

FIG. 12 is a flowchart showing an overview of a second example process for assisting an excavator's operations;

FIG. 13 is a functional block diagram showing a third example functional structure for assisting an excavator's operations;

FIG. 14 is a flowchart showing an overview of a third example process for assisting an excavator's operations;

FIG. 15 is a functional block diagram showing a fourth example functional structure for assisting an excavator's operations;

FIG. 16 is a flowchart showing an overview of a fourth example process for assisting an excavator's operations;

FIG. 17 is a functional block diagram showing a fifth example functional structure for assisting an excavator's operations; and

FIG. 18 is a flowchart showing an overview of a fifth example process for assisting an excavator's operations.

### DETAILED DESCRIPTION

However, the above related art only allows sending commands for specific movements that the work machine can make, such as commands for moving forward, backward, left and right, and commands for excavation; for example, commands for operations tailored to the work environment in which the work machine is working cannot be sent.

The present invention has been made in view of the foregoing, and aims to provide a technique for improving the range of operations that a work machine is able to perform based on commands from the operator in natural language.

Embodiments of the present disclosure will be described below with reference to the accompanying drawings.

### [Overview of Excavator]

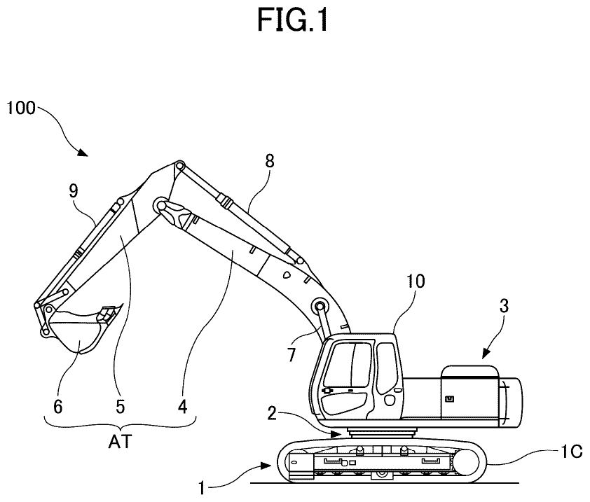

An overview of an excavator 100 according to an embodiment will be described with reference to FIG. 1 to FIG. 3.

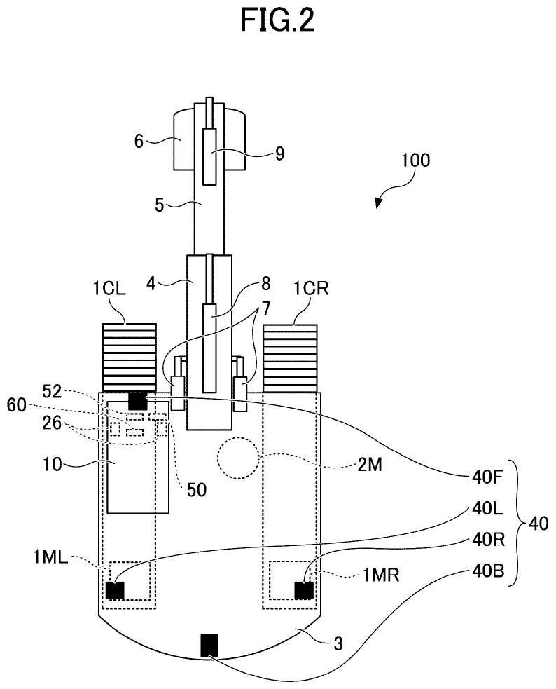

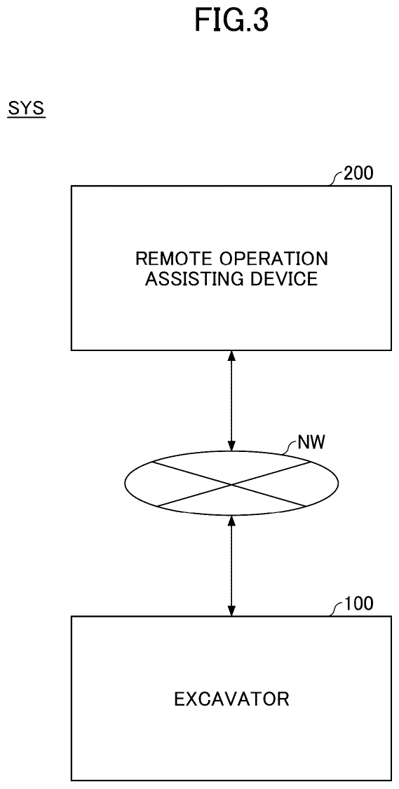

FIG. 1 is a side view showing an example of an excavator 100. FIG. 2 is a top view showing an example of the excavator 100. FIG. 3 is a diagram that shows an example structure that pertains to the remote operations of the excavator 100. In the following description, the direction in which an attachment AT of the excavator 100 extends as viewed from above the excavator 100 (for example, the upward direction in FIG. 2) may be referred to as “front,” and therefore the direction of the excavator 100, or the directions viewed from the excavator 100, will be described accordingly.

As shown in FIG. 1 and FIG. 2, the excavator 100 includes: a lower traveling body 1; an upper traveling body 3; an attachment AT including a boom 4, an arm 5, and a bucket 6; and a cabin 10.

The lower traveling body 1 drives the excavator 100 using crawlers 1C. The crawlers 1C include a left crawler 1CL and a right crawler 1CR. The crawler 1CL is driven hydraulically by a drive hydraulic motor 1ML. Similarly, the crawler 1CL is driven hydraulically by a drive hydraulic motor 1MR. The crawlers 1C allow the lower traveling body 1 to run by itself.

The upper rotating body 3 is mounted rotatably (or in a freely-rotatable fashion) on the lower traveling body 1 via a rotating mechanism 2. For example, the upper rotating body 3 rotates relative to the lower traveling body 1 as the rotating mechanism 2 is driven hydraulically by the rotating hydraulic motor 2M.

The boom 4 is attached to the front center of the upper rotating body 3 such that the boom 4 can be moved upward or downward about a rotating axis that extends in the left-right direction. The arm 5 is attached to the tip of the boom 4 such that the arm 5 can rotate about a rotating axis that extends in the left-right direction. The bucket 6 is attached to the tip of the arm 5 such that the bucket 6 can rotate about the rotating axis that extends in the left-right direction.

The bucket 6 is an example of an end attachment and is used for, for example, excavation, sloping, land-leveling, and so forth.

The bucket 6 is attached to the tip of the arm 5 such that the bucket 6 can be replaced as appropriate, depending on the details of the job that the excavator 100 performs. That is, a bucket of a different type from the bucket 6 may be attached to the tip of the arm 5 instead of the bucket 6. For example, a relatively large bucket, a bucket for sloping, a bucket for dredging, etc.) and so forth may be used. Also, a type of end attachment other than a bucket may be attached to the tip of the arm 5. For example, an agitator, a breaker, a crusher, and so forth may be attached to the tip of the arm 5. Also, a spare attachment such as a quick coupling or a tilt rotator may be provided between the arm 5 and the end attachment.

The boom 4, the arm 5, and the bucket 6 are driven hydraulically by a boom cylinder 7, an arm cylinder 8, and a bucket cylinder 9, respectively.

The cabin 10 is a cab in which the operator sits, and is mounted on the front left side of the upper rotating body 3.

The excavator 100 is equipped with a communication device 60 so that the excavator 100 and a remote operation assisting device 200 can communicate with each other via a predetermined communication network NW.

The communication network NW may be, for example, a local area network (LAN) at the work site. The communication network NW may also be a wide area network (WAN). A wide area networks may refer to, for example, a mobile communication network ending at base stations, a satellite communication network using communication satellites, the Internet, and so forth. The communication network NW may also include, for example, a short-distance communication network based on wireless communication standards such as Wi-Fi and Bluetooth (registered trademark).

For example, the excavator 100 operates responding elements, such as the lower traveling body 1 (that is, a pair of left and right crawlers 1CL and 1CR), the upper rotating body 3, the boom 4, the arm 5, and the bucket 6, in accordance with operations made by the operator aboard the cabin 10.

Also, instead of or in addition to being structured such that the excavator 100 can be operated by the operator aboard the cabin 10, the excavator 100 may also be structured such that it can be operated remotely from outside the excavator 100. When the excavator 100 is operated remotely, the inside of the cabin 10 may be unmanned. Also, when the excavator 100 is one that is dedicated for remote use, the cabin 10 may be omitted. The following description will presume that the operator's operations include at least one of: operations that the operator performs on the operating device 26 in the cabin 10; and remote operations that an external operator performs.

For example, as shown in FIG. 3, “remote operation” uses a remote operation assisting system SYS. In this remote operation assisting system SYS, the excavator 100, which is the target to be operated, and a remote operation assisting device 200, which allows the operator to operate the excavator 10, can communicate with each other via a communication channel NW. To be more specific, the term “remote operations” may refer to, for example, a mode of operation in which the excavator 100 is operated by operation inputs for the actuators of the excavator 100, performed on the remote operation assisting device 200 that can communicate with the excavator 100 through a communication network NW.

The remote operation assisting device 200 may be provided, for example, in a management center where jobs of the excavator 100 are managed from outside. Also, the remote operation assisting device 200 may be a portable operation terminal. In this case, the operator can directly check the status of a job to be performed by the excavator 100 from near the excavator 100, and operate the excavator 100 remotely.

The excavator 100 may transmit, for example, images that show the surrounding environment of the excavator 100 (hereinafter referred to as “surrounding images”), including ones that show the front of the excavator 100, to the remote operation assisting device 200, through the communication device 60, based on images captured by and output from the image capturing devices 40 mounted on the excavator 100. Also, the excavator 100 may transmit the captured images output from the image capturing devices 40 to the remote operation assisting device 200 through the communication device 60, and the remote operation assisting device 200 may process the captured images received from the excavator 100 and generate surrounding images. Then, the remote operation assisting device 200 may display the surrounding images that show the surrounding environment of the excavator 100, including ones that show the front of the excavator 100, on the display device of the remote operation assisting device 200. Also, a variety of information images (information screens) displayed on an output device 50 (display device) provided inside the cabin 10 of the excavator 100 may also be displayed on a display device of the remote operation assisting device 200. By this means, the operator using the remote operation assisting device 200 can operate the excavator 100 remotely, while checking the images showing the surrounding environment of the excavator 100 on the display device, the contents displayed on the information screen, and so forth. Then, the excavator 100 may run the actuators and drive the respective responding elements, such as the lower traveling body 1, the upper rotating body 3, the boom 4, the arm 5, and the bucket 6, in accordance with the remote operation signals that indicate the details of remote operations transmitted from the remote operation assisting device 200 by the communication device 60. By this means, the remote operation assisting system SYS can allow the excavator 100 to be operated remotely by using the remote operation assisting device 200.

Furthermore, the term “remote operation” may refer to a mode of operation in which, for example, the excavator 100 is operated based on external sound/voice inputs or gesture inputs from people (for example, workers) around the excavator 100. To be more specific, the excavator 100 may recognize the voices spoken by nearby workers, their gestures, and so forth, through a sound input device (for example, a microphone) or a gesture input device (for example, an image capturing device) mounted on the excavator 100. Then, the excavator 100 may run the actuators according to the contents of the recognized voices and gestures, and drive the responding elements such as the lower traveling body 1 (that is, the crawlers 1CL and 1CR), upper rotating body 3, boom 4, arm 5, and bucket 6.

Also, the excavator 100 may run the actuators automatically, regardless of the details of operations made by the operator. By this means, the excavator 100 can implement a function to automatically operate at least some of the responding elements such as the lower traveling body 1, the upper rotating body 3, and the attachment AT. This function is also commonly known as an “autonomous driving function,” “machine control (MC) function,” and so forth.

An autonomous driving function may refer to, for example, a semi-autonomous driving function (operation-assisting MC function). The semi-autonomous driving function here may refer to a function to automatically operate some elements (actuators) to be driven, other than the elements (actuators) to be driven and to be operated, in accordance with operations by the operator. Also, the autonomous driving function may refer to a fully-autonomous driving function (fully-autonomous MC function). The fully-autonomous driving function may refer to a function to automatically operate at least some of the multiple responding elements (hydraulic actuators) on the assumption that the operator makes no operations. In the event the fully-autonomous driving function is enabled in the excavator 100, the interior of the cabin 10 may be unmanned. Also, when the excavator 100 is one that is dedicated to fully-autonomous driving use, the cabin 10 may be omitted. Also, the semi-autonomous driving function or the fully-autonomous driving function may refer to, for example, a rule-based autonomous driving function. A rule-based autonomous driving function is an example autonomous driving function in which the details in which the elements (actuators) to be driven and subject to autonomous driving are operated are determined autonomously according to rules specified in advance. Also, the semi-autonomous driving function and the fully-autonomous driving function may include an autonomous driving function. The autonomous driving function here may refer to a function which allows the excavator 100 to make various decisions autonomously, and in which the details of operations to be performed on the elements (hydraulic actuators) that are to be driven and subject to autonomous driving are determined in accordance with the decisions of the excavator 100.

Also, the job of the excavator 100 may be monitored remotely. In this case, a remote monitoring assisting device having the same functions as those of the remote operation assisting device 200 may be employed. The remote monitoring assisting device may be, for example, the remote operation assisting device 200. By this means, a supervisor, who may be the user of the remote monitoring assisting device, can monitor the status of the job to be performed by the excavator 100, while also checking the surrounding images displayed on the display device of the remote operation assisting device. Also, for example, if the supervisor judges it necessary, from the viewpoint of safety, the supervisor may intervene in the excavator 100's operation by the operator or autonomous driving of the excavator 100, and force the excavator 100 to an emergency stop by making a predetermined input using the input device of the remote monitoring assisting device.

### <Structure of Excavator 100>

Next, a structure of the excavator 100 will be described below in detail with reference to the accompanying drawings.

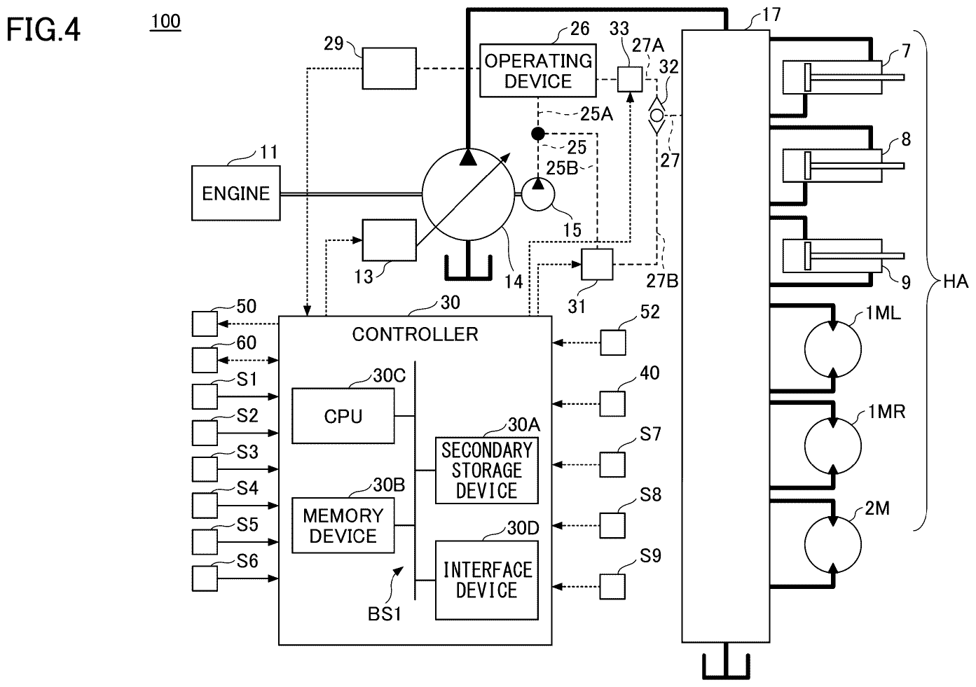

FIG. 4 is a diagram that shows an example structure of the excavator 100.

Note that, in FIG. 4: the bold solid lines are paths on which mechanical drive force travels; the thin solid lines are paths on which the high-pressure hydraulic oil for driving the hydraulic actuators travels; the dashed lines are paths on which the pilot pressure travels; and the dotted lines are paths on which electric signals travel.

The excavator 100 may include various components, such as those constituting a hydraulic drive system for hydraulically driving the responding elements, an operation system for operating the responding elements, a user interface system for exchanging information with users, a communication system for communicating with outside, and a control system for implementing various controls.

### <<Hydraulic Drive System>>

As shown in FIG. 4, the hydraulic drive system of the excavator 100 may include hydraulic actuators HA. The hydraulic actuators HA may hydraulically drive respective responding elements including the lower traveling body 1 (that is, the crawlers 1CL and 1CR), the upper rotating body 3, the boom 4, the arm 5, and the bucket 6, which have been described earlier. Also, the hydraulic drive system of the excavator 100 according to the present embodiment may include an engine 11, a regulator 13, a main pump 14, and a control valve 17.

The hydraulic actuators HA may include drive hydraulic motors 1ML and 1MR, a rotating hydraulic motor 2M, a boom cylinder 7, an arm cylinder 8, and a bucket cylinder 9, and so forth.

Note that, in the excavator 100, some or all of the hydraulic actuators HA may be replaced with an electric actuator. That is, the excavator 100 may be a hybrid excavator or an electric excavator.

The engine 11 may be the motor of the excavator 100 and the main power source in the hydraulic drive system. The engine 11 may be, for example, a diesel engine that runs on light oil. The engine 11 may be mounted, for example, in a rear part of the upper rotating body 3. The engine 11 may rotate at a constant speed at a pre-configured target number of rotations per unit time, under direct or indirect control of the controller 30 (described later), thereby driving the main pump 14 and a pilot pump 15.

Note that, instead of or in addition to the engine 11, another motor (for example, an electric motor) may be mounted on the excavator 100.

The regulator 13 may control (adjust) the amount of discharge from the main pump 14 under the control of the controller 30. For example, the regulator 13 may adjust the angle of the swashplate of the main pump 14 (hereinafter referred to as “tilting angle”) in accordance with control commands from the controller 30.

The main pump 14 may supply hydraulic oil to the control valve 17 through a high-pressure hydraulic line. The main pump 14 may be attached to the rear part of the upper rotating body 3, like the engine 11, for example. The main pump 14 may be driven by the engine 11, as described earlier. The main pump 14 may be, for example, a variable displacement hydraulic pump. As described earlier, under the control of the controller 30, the tilting angle of the swashplate may be adjusted by the regulator 13, so that the piston stroke length is adjusted, and the discharge flow rate, discharge pressure, and so forth are controlled.

The control valve 17 may drive the hydraulic actuators HA in accordance with the details of operations that the operator performs on the operating device 26, the details of remote operations, or operation commands supporting the autonomous driving function of the excavator 100. The control valve 17 may be mounted, for example, in the center of the upper rotating body 3. As mentioned earlier, the control valve 17 may be connected to the main pump 14 via a high-pressure hydraulic line, and selectively supply hydraulic oil supplied from the main pump 14 to each hydraulic actuator in response to the operator's operation or the operation command supporting the autonomous driving function of the excavator 100. To be more specific, the control valve 17 may include multiple control valves that control the rate and direction of flow of hydraulic oil supplied from the main pump 14 to each hydraulic actuator HA (also referred to as “direction switching valves”).

### <<Operation System>>

As shown in FIG. 4, the operation system of the excavator 100 may include a pilot pump 15, an operating device 26, a hydraulic control valve 31, a shuttle valve 32, and a hydraulic control valve 33.

The pilot pump 15 may supply pilot pressures to various hydraulic equipment via a pilot line 25. The pilot pump 15, like the engine 11, may be attached to the rear part of the upper rotating body 3. The pilot pump 15 may be, for example, a fixed displacement hydraulic pump, and driven by the engine 11 as described earlier.

Note that the pilot pump 15 may be omitted. In this case, relatively high-pressure hydraulic oil may be discharged from the main pump 14, and its pressure may be reduced by means of a predetermined pressure-reducing valve. The resulting relatively low-pressure hydraulic oil may be supplied to various hydraulic equipment as a pilot pressure.

The operating device 26 may be provided near the cockpit of the cabin 10 and used by the operator to operate various responding elements. To be more specific, the operating device 26 may be used by the operator to operate the hydraulic actuators HA for driving respective responding elements. As a result of this, the operator may be able to operate the responding elements, driven by the hydraulic actuators HA. The operating device 26 may be, for example, a pedal device, a lever device, and the like, for operating respective responding elements (hydraulic actuators HA).

For example, as shown in FIG. 4, the operating device 26 may be a hydraulic pilot device. To be more specific, the operating device 26 may use the hydraulic oil supplied from the pilot pump 15 through the pilot line 25 and a pilot line 25A branching from the pilot line 25, and output suitable pilot pressures (that is, pressures that match the details of corresponding operations) to the secondary pilot line 27A. The pilot line 27A may be connected to one inlet port of the shuttle valve 32, and connected to the control valve 17 via the pilot line 27 connected to an outlet port of the shuttle valve 32. By this means, the control valve 17 may receive, as inputs, pilot pressures that match the details of operations performed on the operating device 26 with respect to various responding elements (hydraulic actuators HA), through the shuttle valve 32. As a consequence, the control valve 17 can drive the hydraulic actuators HA according to the details of operations made on or with respect to the operating device 26 by the operator or the like.

Also, the operating device 26 may be an electric one. In this case, the pilot line 27A, the shuttle valve 32, and the hydraulic control valve 33 may be omitted. To be more specific, the operating device 26 may outputs electric signals (hereinafter referred to as “operation signals”) that match the details of operations made, and the operation signals may be input to the controller 30. Then, the controller 30 may output control commands according to the operation signals' contents (that is, control signals that match the details of operations made on or with respect to the operating device 26), to the hydraulic control valve 31. By this means, the hydraulic control valve 31 may receive, as inputs, pilot pressures that match the details of operations made on or with respect to the operating device 26, to the control valve 17, so that the control valve 17 can drive the individual hydraulic actuators HA according to the details of operations made on or with respect to the operating device 26.

Also, the control valves (direction switching valves) built in the control valve 17 for driving respective hydraulic actuators HA may be electromagnetic solenoid valves. In this case, operation signals output from the operating device 26 may be directly input to the control valve 17 (that is, directly to the electromagnetic solenoid control valves).

Also, as described earlier, some or all of the hydraulic actuators HA may be replaced with electric actuators. In this case, the controller 30 may output control commands that match the details of operations made on or with respect to the operating device 26, or the details of remote operations indicated by remote operation signals, to the electric actuators or the drivers for driving the electric actuators. Also, when the excavator 100 is operated remotely, the operating device 26 may be omitted. Also, when the excavator 100 is operated remotely, or when the excavator 100 is operated via natural language as will be described later, the operating device 26 may be omitted.

A hydraulic control valve 31 may be provided for every responding element (that is, for every hydraulic actuator HA) that works in conjunction with operations made on or with respect to the operating device 26, in every direction in which the responding elements (hydraulic actuators HA) might move (for example, the directions in which the boom 4 rises and drops). For example, two hydraulic control valves 31 are provided for each double-acting hydraulic actuator HA for driving the lower traveling body 1, upper rotating body 3, boom 4, arm 5, bucket 6, and so forth. A hydraulic control valve 31 may be provided in the pilot line 25B between the pilot pump 15 and the control valve 17, for example, and structured such that the flow path area (that is, the cross-sectional area in which the hydraulic oil can flow) can be changed. By this means, the hydraulic control valve 31 can output certain pilot pressures to the secondary pilot line 27B by using hydraulic oil supplied from the pilot pump 15 through the pilot line 25B. Therefore, through the shuttle valve 32 provided between the pilot line 27B and the pilot line 27, the hydraulic control valve 31 can apply, indirectly, certain pilot pressures that match control signals from the controller 30, to the control valve 17. As a consequence, for example, the controller 30 can supply pilot pressures that match operation commands supporting the autonomous driving function of the excavator 100, from the hydraulic control valve 31 to the control valve 17, thereby enabling the excavator 100 to operate based on its autonomous driving function.

Also, the controller 30 may control the hydraulic control valve 31 and operate the excavator 100 remotely. To be more specific, the controller 30 may output control signals that match the details of remote operations indicated by remote operation signals from the remote operation assisting device 200, to the hydraulic control valve 31, via the communication device 60. By this means, the controller 30 can supply pilot pressures that match the details of remote operations, from the hydraulic control valve 31 to the control valve 17, thereby enabling the excavator 100 to operate based on the operator's remote operations.

Also, when the operating device 26 is an electric one, the controller 30 can directly supply pilot pressures that match the details of operations (operation signals) made on or with respect to the operating device 26, from the hydraulic control valve 31 to the control valve 17, thereby enabling the excavator 100 to operate based on the operator's operations.

Every shuttle valve 32 has two inlet ports and one outlet port. When varying pilot pressures are input to the two inlet ports, the shuttle valve 32 outputs hydraulic oil having the higher pilot pressure to the outlet port. Similar to the hydraulic control valve 31, the shuttle valve 32 is provided per responding element (hydraulic actuator HA) that works in conjunction with operations performed on or with respect to the operating device 26, and per direction in which the corresponding driven element (hydraulic actuator HA) moves. For example, two shuttle valves 32 are provided per double-acting hydraulic actuator HA for driving the lower traveling body 1, upper rotating body 3, boom 4, arm 5, bucket 6, and so forth. One of the two inlet ports of every shuttle valve 32 is connected to a secondary pilot line 27A of the operating device 26 (to be more specific, the above-mentioned lever device or pedal device included in the operating device 26), and the other one is connected to a pilot line 27B, which is a secondary pilot line, of the hydraulic control valve 31. The outlet port of each shuttle valve 32 is connected to the pilot port of the corresponding control valve in the control valve 17 through the pilot line 27. A shuttle valve 32's “corresponding control valve” refers to at least one control valve for driving a hydraulic actuator HA that works in conjunction with the operation of the above-mentioned lever device or pedal device connected to one inlet port of the shuttle valve 32. Therefore, these shuttle valves 32 can apply the higher one of: the pilot pressure of the secondary pilot line 27A of the operating device 26; and the pilot pressure of the secondary pilot line 27B of the hydraulic control valve 31, to the pilot ports of respective corresponding control valves. That is, the controller 30 allows the hydraulic control valve 31 to output pilot pressures that are higher than the secondary pilot pressure in the operating device 26, so that the corresponding control valves can be controlled regardless of the operation of the operating device 26 by the operator. Consequently, the controller 30 can control the operation of the driven elements (the lower traveling body 1, upper rotating body 3, boom 4, arm 5, and bucket 6) and implement the autonomous driving function, remote operation function, and so forth of the excavator 100, regardless of how or in what way the operator maneuvers the operating device 26.

The hydraulic control valve 33 may be provided in the pilot line 27A that connects between the operating device 26 and the shuttle valve 32. The hydraulic control valve 33 may be, for example, structured such that its flow path area can be changed. The hydraulic control valve 33 operates in accordance with control signals received as inputs from the controller 30. By this means, when the operating device 26 is operated by an operator, the controller 30 can forcibly reduce the pilot pressures output from the operating device 26. Therefore, even when the operating device 26 is operated, the controller 30 can prevent or substantially prevent the hydraulic actuators HA from operating in accordance with operations made on or with respect to the operating device 26 from operating, or force the operation of the hydraulic actuators HA to a stop. Also, even when the operating device 26 is operated, the controller 30 can reduce the pilot pressures output from the operating device 26 below the pilot pressures output from the hydraulic control valve 31. Therefore, by controlling the hydraulic control valve 31 and the hydraulic control valve 33, the controller 30 can reliably apply desired pilot pressures to the pilot ports of individual control valves in the control valve 17, regardless of the details of operations made on or with respect to the operating device 26. Consequently, the controller 30 can implement the autonomous driving function, the remote operation function, and so forth of the excavator 100 more properly by controlling the hydraulic control valves 33 in addition to the hydraulic control valves 31, for example.

### <User Interface System>

As shown in FIG. 4, the user interface system of the excavator 100 may include an operating device 26, an output device 50, and an input device 52.

The output device 50 may output a variety of information to the user of the excavator 100 (for example, the operator in the cabin 10, the remote operator or the like.) and to people around the excavator 100 (for example, workers, the drivers of work vehicles, etc.).

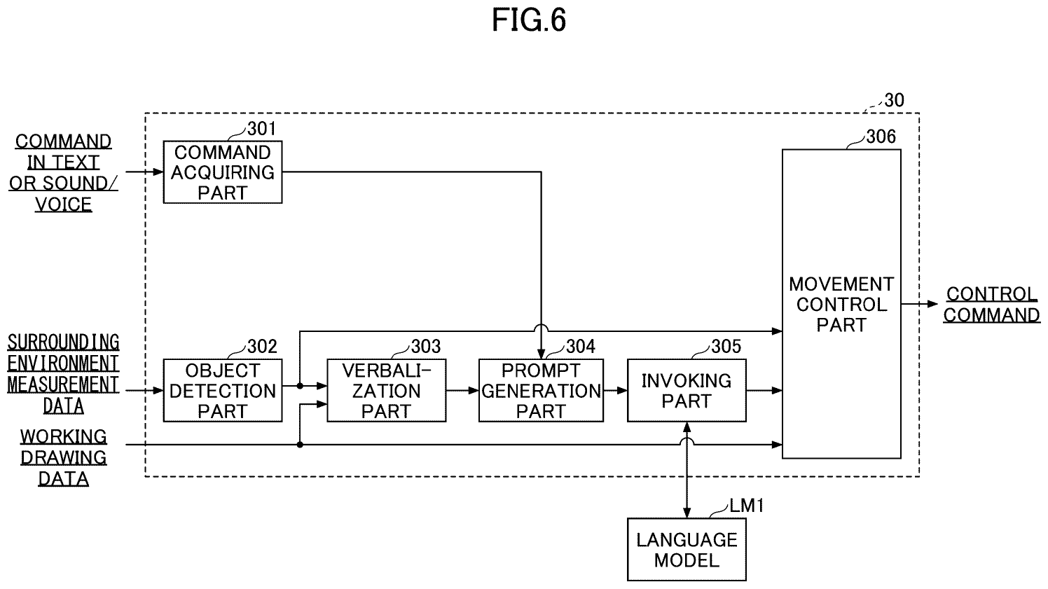

For example, the output device 50 may include lighting equipment and a display device 50A (see FIG. 6) that output a variety of information in a visualized manner. The lighting equipment may include, for example, a warning light (indicator lamp). The display device 50A may be, for example, a liquid crystal display or an organic electroluminescence (EL) display. For example, as shown in FIG. 2, the lighting equipment and the display device 50A may be provided inside the cabin 10, and output a variety of information in a visualized manner to the operator in the cabin 10. Also, the lighting equipment and the display device 50A may be provided, for example, on a side surface of the upper rotating body 3 and output a variety of information in a visualized manner to workers around the excavator 100.

Also, the output device 50 may include a sound output device that outputs a variety of information in an auditory manner. The sound output device may be, for example, a buzzer or a speaker. The sound output device may be provided, at least, either inside or outside the cabin 10, and output a variety of information in an auditory manner, to the operator inside the cabin 10 or people (for example, workers) around the excavator 100.

Also, the output device 50 may include a device that outputs a variety of information in a tactile manner, such as by vibration of the cockpit.

The input device 52 may receive various inputs from the user of the excavator 100, and signals corresponding to the received inputs are taken into the controller 30. For example, as shown in FIG. 2, the input device 52 may be provided inside the cabin 10 and receive inputs from the operator in the cabin 10 or the like. Also, the input device 52 may be provided, for example, on a side surface or somewhere in the upper rotating body 3 and receives inputs from the workers or the like around the excavator 100.

For example, the input device 52 may be a mechanical input device that receives the mechanical operations that the user performs thereon as inputs. This mechanical input device may include: a touch panel implemented on the display device 50A; a touch pad, a button switch, a lever, a toggle, and so forth provided so as to surround the display device 50A; and a knob switch provided on operating device 26 (lever device).

Also, the input device 52 may include a sound input device that receives sound/voice inputs from the user. The sound input device may be a microphone, for example.

Also, the input device 52 may be a gesture input device that receives gesture inputs from the user. The gesture input device may include, for example, an image capturing device that captures images of gestures made by the user.

Also, the input device 52 may be a biological input device that receives biological inputs from the user. The biological inputs may include, for example, biological information such as the user's fingerprint, iris, and so forth.

### <<Communication System>>

As shown in FIG. 4, the communication system of the excavator 100 according to the present embodiment may include a communication device 60.

The communication device 60 may connect with an external communication network NW and communicate with devices provided apart from the excavator 100. These devices may include ones situated outside the excavator 100, as well as a portable terminal device that the user of the excavator 100 carries into the cabin 10 with him/her. The communication device 60 may include, for example, a mobile communication module conforming to standards such as 4G (4th Generation) and 5G (5th Generation). The communication device 60 may also include, for example, a satellite communication module. The communication device 60 may also include, for example, a Wi-Fi communication module or a Bluetooth (registered trademark) communication module. Also, when there are multiple connectable communication networks NW, the communication device 60 may include multiple communication devices in accordance with the types of the communication networks NW.

For example, the communication device 60 may communicate with external devices such as the remote operation assisting device 200 and remote operation assisting device 200 within the work site through a local communication line established at the work site. The local communication line may be, for example, a local 5G (also commonly known as “local 5G”) mobile communication line established at the work site or a local network based on Wi-Fi 6.

The communication device 60 may also communicate with the remote operation assisting device 200, sensor group 300, remote operation assisting device 200, and so forth, situated outside the work site, through a wide-area communication line covering the work site, that is, a wide-area network.

### <<Control System>>

As shown in FIG. 4, the control system of the excavator 100 may include a controller 30. Also, the control system of the excavator 100 according to the present embodiment may include an operation pressure sensor 29, sensors 40, and sensors S1 to S9.

The controller 30 may control the excavator 100 in a variety of ways.

The functions of the controller 30 may be implemented by any hardware or by any combination of hardware and software. For example, as shown in FIG. 3, the controller 30 may include a secondary memory device 30A, a memory device 30B, a central processing part (CPU) 30C, and an interface device 30D, which are all connected via a bus BS1.

The secondary memory device 30A may be a non-volatile storage means that stores the programs that are installed, as well as necessary files and data. The secondary memory device 30A may be, for example, an electrically erasable programmable read-only memory (EEPROM), a flash memory, or the like.

The memory device 30B may, for example, load a program in the secondary memory device 30A so that the CPU 30C can read it when there is a command to start the program. The memory device 30B may be, for example, a static random access memory (SRAM).

The CPU 30C may, for example, execute a program loaded in the memory device 30B and implement a variety of functions of the controller 30 according the program's instructions.

The interface device 30D may, for example, function as a communication interface for connecting with the internal communication network of the excavator 100. The interface device 30D may include a variety of types of communication interfaces, used depending on the type of the communication network to which it is connected.

Also, the interface device 30D may function as an external interface for reading data from a recording medium and writing data to the recording medium. The recording medium may, for example, be a dedicated tool connected to a connector installed inside the cabin 10 by a detachable cable. Also, the recording medium may be, for example, a general-purpose recording medium such as an SD memory card or a universal serial bus (USB) memory. By this means, a program for implementing a variety of functions of the controller 30 may be provided, for example, by a portable recording medium, and installed in the secondary memory device 30A of the controller 30. Also, a program may be downloaded from another computer (for example, the remote operation assisting device 200) outside the excavator 100, through the communication device 60, and installed in the secondary memory device 30A.

Note that some of the functions of the controller 30 may be implemented by other controllers (control devices). In other words, the functions of the controller 30 may be distributed over and implemented by multiple controllers mounted on the excavator 100.

The operation pressure sensor 29 may detect secondary pilot pressures (pressures on the pilot line 27A) in the hydraulic-pilot operating device 26. That is, the operation pressure sensor 29 may detects pilot pressures that match the way in which the individual driven elements (hydraulic actuators) in the operating device 26 are operated. Pilot-pressure detection signals, produced by the operation pressure sensor 29 and indicating the way each individual driven element (hydraulic actuator HA) is operated in the operating device 26, may be taken into the controller 30.

Note that the operation pressure sensor 29 may be omitted when the operating device 26 is an electric one. This is because the controller 30 can learn the operating state of each driven element, through the operating device 26, based on operation signals received from the operating device 26.

The image capturing device 40 may capture images of the surrounding environment of the excavator 100.

The image capturing device 40 may be, for example, a monocular camera. The image capturing device 40 may also be a three-dimensional camera (3D camera) that can acquire not only two-dimensional image information but also three-dimensional information including information regarding the distance to an object shown in the image and the depth of the image, such as a stereo camera, a ToF (Time of Flight) camera, or a depth camera.

For example, as shown in FIG. 2, the image capturing device 40 may include cameras 40F, 40B, 40L, and 40R. The camera 40F may capture images of the front of the upper rotating body 3. The camera 40B may capture images of the rear of the upper rotating body 3. The camera 40L may capture images of the left side of the upper rotating body 3. The camera 40R may capture images of the right side of the upper rotating body 3. By this means, the image capturing device 40 can capture the entire circumference of the excavator 100, i.e., a range covering an angular direction of 360 degrees, when viewed from above. The cameras 40F, 40B, 40L, and 40R may be referred to collectively or individually as “camera(s) 40X.”

The output data of the image capturing device 40 (the camera 40X) may be captured by the controller 30 via a one-to-one communication line or an in-vehicle network. By this means, for example, the controller 30 can learn the state of the periphery of the excavator 100 based on the output data of the camera 40X.

Note that some or all of the cameras 40B, 40L, and 40R may be omitted. Also, the excavator 100 may be provided with a ranging sensor (also referred to as a “distance sensor”) capable of acquiring information indicating the distance to an object in the periphery of the excavator 100, instead of or in addition to the image capturing device 40. The ranging sensor may be, for example, a light detecting and ranging (LIDAR) sensor, a millimeter wave radar, an ultrasonic sensor, etc.

The sensor S1 may be attached to the boom 4 and measure the posture of the boom 4. The sensor S1 may output measurement data that represents the posture of the boom 4. The posture of the boom 4 may be, for example, the posture/angle (hereinafter referred to as “boom angle”) of the proximal end of the boom 4 about the rotating axis. The proximal end of the boom 4 may be, for example, the part of the boom 4 connecting with the upper rotating body 3. The sensor S1 may be, for example, a rotary potentiometer, a rotary encoder, an acceleration sensor, an angular acceleration sensor, a 6-axis sensor, an inertial measurement part (IMU), and so forth. The same may be true for the sensors S2 to S4. The sensor S1 may also be a cylinder sensor that detects the extended/retracted position of the boom cylinder 7. The same may be true for the sensors S2 and S3. The outputs of the sensor S1 may be input to the controller 30 (measurement data that represents the posture of the boom 4). By this means, the controller 30 can learn the posture of the boom 4.

The sensor S2 may be attached to the arm 5 and measures the posture of the arm 5. The sensor S2 may output measurement data that represents the posture of the arm 5.

The posture of the arm 5 may be, for example, the posture/angle of the proximal end of the arm 4 (hereinafter referred to as “arm angle”) about the rotating axis. The proximal end of the arm 4 may be, for example, the part of the arm 4 connecting with the boom 4. The outputs of the sensor S2 (measurement data that represents the posture of the arm 5) may be input to the controller 30. By this means, the controller 30 can learn the posture of the arm 5.

The sensor S3 may be attached to the bucket 6 and measure the posture of the bucket 6. The sensor S3 may output measurement data that represents the posture of the bucket 6. The posture of the bucket 6 may be, for example, the posture/angle of the proximal end of the bucket 6 (hereinafter referred to as “arm angle”) about the rotating axis. The proximal end of the bucket may be, for example, the part of the bucket 6 connecting with the arm 5. The outputs of the sensor S3 may be taken into the controller 30 (measurement data that represents the posture of the bucket 6). By this means, the controller 30 can learn the posture of the bucket 6.

The sensor S4 may measure the posture of the body (for example, the upper rotating body 3) of the excavator 100. The sensor S4 may output measurement data that represents the posture of the body of the excavator 100. The posture of the body of the excavator 100 may be, for example, the tilt of the body relative to a specific reference plane (for example, a horizontal plane). For example, the sensor S4 may be attached to upper rotating body 3 and measure the tilting angles about two axes (hereinafter referred to as “front-to-back tilting angle” and “left-to-right tilting angle”), one in the front-to-back direction and the other one in the left-right direction with respect to the excavator 100. The outputs of the sensor S4 (measurement data that represents the posture of the body of the excavator 100) may be taken into the controller 30. By this means, the controller 30 can learn the posture (tilt) of body (the upper rotating body 3) of the excavator 100.

The sensor S5 may be attached to the upper rotating body 3 and measure the rotation of the upper rotating body 3. The sensor S5 may output measurement data that represents the rotation of the upper rotating body 3. The sensor S5 may measure, for example, the rotating angular velocity and rotating angle of the upper rotating body 3. The sensor S5 may be, for example, a gyro sensor, a resolver, a rotary encoder, and so forth. The outputs of the sensor S5 (measurement data that represents the rotation of the upper rotating body 3) may be taken into the controller 30. By this means, the controller 30 can learn the rotation of the upper rotating body 3, such as the rotating angle.

The controller 30 can identify (estimate) the position of the tip (the bucket 6) of the attachment AT based on the output of the sensors S1 to S5.

Note that if the sensor S4 includes a gyro sensor, 6-axis sensor, IMU, or the like that can detect the angular velocity about three axes, the rotation of the upper rotating body 3 may be detected based on detection signals of the sensor S4 (for example, the rotating angular velocity). In this case, the sensor S5 may be omitted.

The sensor S6 may measure the position of the excavator 100. The sensor S6 may measure the position in a world (global) coordinate system or using local coordinates at the work site. In the former case, the sensor S6 may be, for example, a global navigation satellite system (GNSS) sensor. In the latter case, the sensor S6 may be a transceiver that communicates with a device that serves as a point of reference for the work site's position, and output a signal corresponding to the position of the excavator 100 relative to the point of reference. The outputs of the sensor S6 may be taken into the controller 30.

The sensor S7 may measure the pressure (cylinder pressure) in the oil chamber of the boom cylinder 7. The sensor S7 may be, for example, a sensor that measures the cylinder pressure (rod pressure) in the rod-side oil chamber of the boom cylinder 7 and a sensor that measures the cylinder pressure in the bottom-side oil chamber (bottom pressure). The outputs of the sensor S7 (measurement data of the cylinder pressure of the boom cylinder 7) may be input to the controller 30.

The sensor S8 may measure the pressure (cylinder pressure) of the oil chamber of the arm cylinder 8. The sensor S8 may be, for example, a sensor that measures the cylinder pressure (rod pressure) of the rod-side oil chamber of the arm cylinder 8, and a sensor that measures the cylinder pressure (bottom pressure) of the bottom-side oil chamber of the arm cylinder 8. The outputs of the sensor S8 (measurement data of the cylinder pressure of the arm cylinder 8) may be input to the controller 30.

The sensor S9 may measure the pressure (cylinder pressure) of the oil chamber of the bucket cylinder 9. The sensor S9 may be, for example, a sensor that measures the cylinder pressure (rod pressure) of the rod-side oil chamber of the bucket cylinder 9, and a sensor that measures the cylinder pressure (bottom pressure) of the bottom-side oil chamber of the bucket cylinder 9. The outputs of the sensor S9 (measurement data of the cylinder pressure of the bucket cylinder 9) may be input to the controller 30.

The controller 30 can learn the state of load acting on the attachment AT based on the output of the sensors S7 to S9. The load that acts on the attachment AT may include, for example, the reactive force acting on the bucket 6 from the objects in the work range and the weight of earth and sand (for example, ground soil) caught in the bucket 6.

Note that some or all of the sensors S1 to S9 may be omitted, depending on necessity. Also, in addition to the sensors S1 to S9, the excavator 100 may be equipped with other sensors whereby the state of the excavator 100 can be learned. For example, the excavator 100 may be equipped with an orientation sensor that can detect its own orientation. The orientation sensor may be, for example, an electronic compass including a geomagnetic sensor.

### <Structure of Remote Operation Assisting Device>

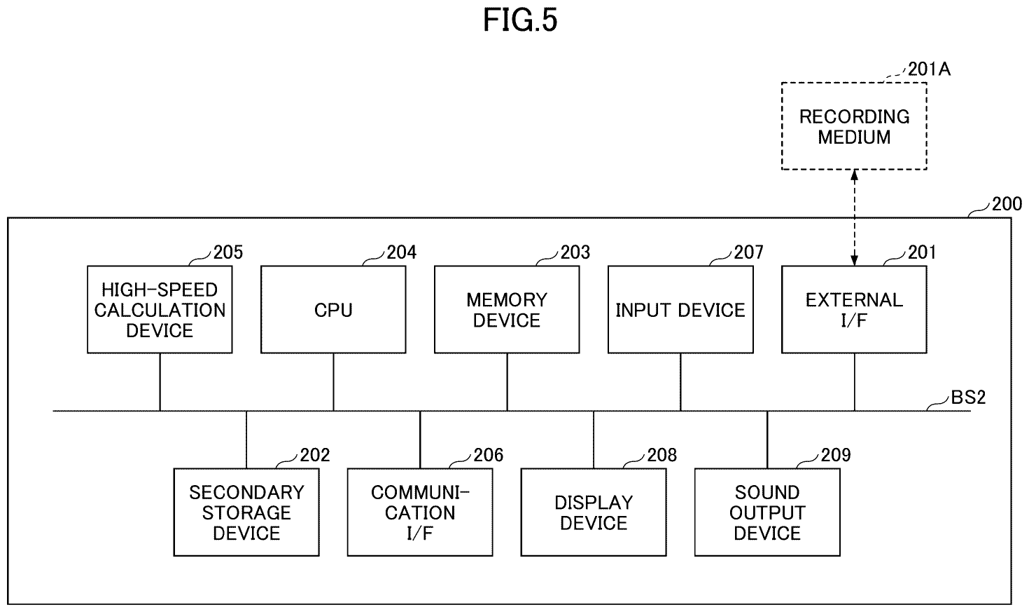

Next, a structure of the remote operation assisting device 200 will be described below with reference to FIG. 5.

FIG. 5 is a diagram that shows an example structure of a remote operation assisting device 200.

The functions of the remote operation assisting device 200 may be implemented by any hardware or any combination of hardware and software. For example, as shown in FIG. 5, the remote operation assisting device 200 may include an external interface 201, a secondary storage device 202, a memory device 203, a CPU 204, a high-speed calculation device 205, a communication interface 206, an input device 207, a display device 208, and a sound output device 209. These may all be connected by a bus BS2.

The external interface 201 may function as an interface for reading data from a recording medium 201A and for writing data to the recording medium 201A. The recording medium 201A may be, for example, a flexible disk, a compact disc (CD), a digital versatile disc (DVD), a Blu-ray (registered trademark) disc (BD), a secure digital (SD) memory card, a universal serial bus (USB) memory, and the like. By this means, the remote operation assisting device 200 can read various data used in various processes through the recording medium 201A and store the data in the secondary storage device 202, or install programs for implementing a variety of functions.

Note that the remote operation assisting device 200 may acquire various data and programs used in various processes from external devices via the communication interface 206.

The secondary storage device 202 may store various programs installed, as well as files and data necessary for various processes. The secondary storage device 202 may include, for example, a hard disc drive (HDD), a solid state drive (SSD), a flash memory, and so forth.

When a command to start a program is received, the memory device 203 may read the program from the secondary storage device 202 and stores it. The memory device 203 may include, for example, a dynamic random access memory (DRAM), a static random access memory (SRAM), and the like.

The CPU 204 may execute various programs loaded from the secondary storage device 202 to the memory device 203, and implement a variety of functions related to the remote operation assisting device 200 according to the programs.

The high-speed calculation device 205 may work in conjunction with the CPU 204 to perform calculation processes at a relatively high speed. The high-speed calculation device 205 may be, for example, a graphics processing part (GPU), an application-specific integrated circuit (ASIC), a field-programmable gate array (FPGA), and so forth.

Note that the high-speed calculation device 205 may be omitted, depending on the speed required in the calculation processes.

The communication interface 206 may be used as an interface for allowing communication with external devices. By this means, the remote operation assisting device 200 can communicate with external devices such as, for example, the excavator 100, through the communication interface 206. Also, the communication interface 206 may include and choose between multiple types of communication interfaces depending on what communication method is applied to communication with connecting devices, and so on.

The input device 207 may receive various inputs from the user. The input device 207 may include a remote operation device for operating the excavator 100 remotely.

The input device 207 may be, for example, an input device (hereinafter referred to as “mechanical input device”) that receives mechanical operation inputs from the user. When the excavator 100 is operated remotely, the operating device for the remote operation may be a mechanical input device. The “mechanical input device” in this case may be, for example, a button, a toggle, a lever, a keyboard, a mouse, a touch panel implemented in the display device 208, a touch pad provided apart from the display device 208, and so on.

Also, the input device 207 may include a sound input device that can accept sound/voice inputs from the user. The sound input device may, for example, include a microphone that can collect the user's voice.

Also, the input device 207 may include a gesture input device that can recognize and receive the user's gestures as inputs. The gesture input device may, for example, include a camera that can capture images of the user's gestures.

Also, the input device 207 may include a biological input device that can receive the user's biological inputs. The biological input device may be, for example, a camera that can acquire image data containing information about the user's fingerprint or iris.

The display device 208 may show an information screen or an operation screen to the user of the remote operation assisting device 200. The display device 208 may, for example, be an LCD display or an organic EL display.

The sound output device 209 may communicate a variety of information to the user of the remote operation assisting device 200 through sound. The sound output device 209 may be, for example, a buzzer, an alarm, a speaker, and so forth.

### [First Example Functional Structure for Assisting Excavator's Operation]

Next, a first example functional structure related to assisting the operation of the excavator 100 will be described below with reference to FIG. 6 to FIG. 9, in addition to FIG. 1 to FIG. 5.

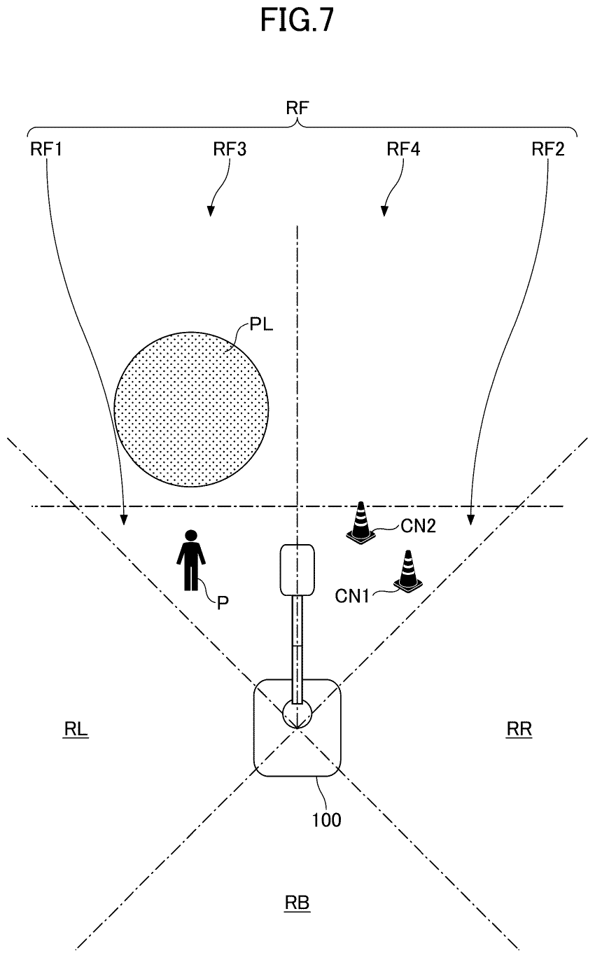

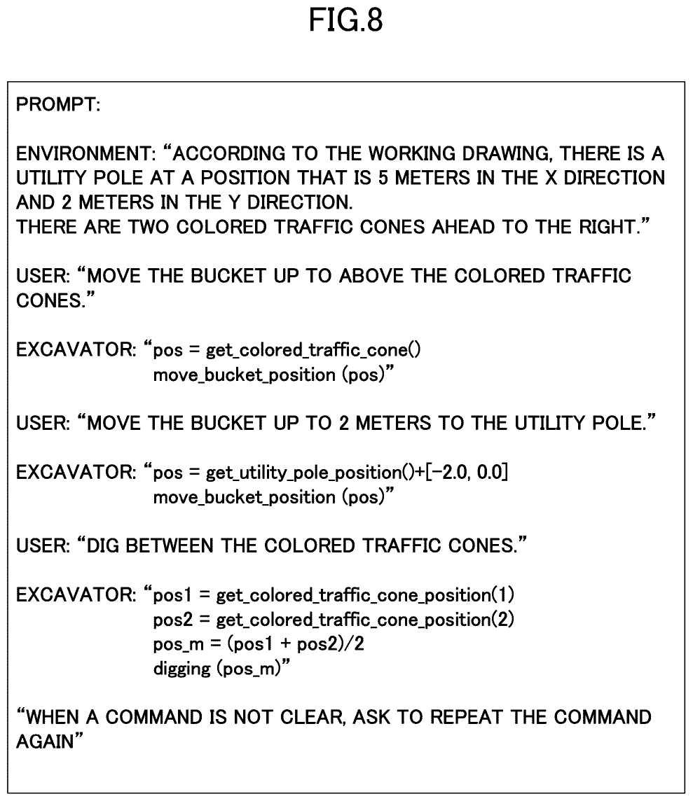

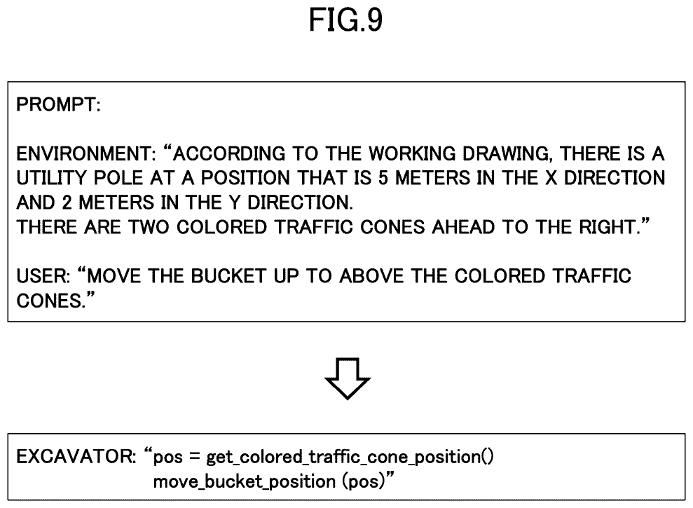

FIG. 6 is a functional block diagram showing a first example functional structure related to assisting the operation of the excavator 100. FIG. 7 is a diagram showing an example surrounding environment of the excavator 100. FIG. 8 is a diagram showing an example exercise given to a language model LM1. FIG. 9 is a diagram showing an example combination of a prompt and an output of the language model LM1.

As shown in FIG. 6, the controller 30 may include, as its functional parts, a command acquiring part 301, an object detection part 302, a verbalization part 303, a prompt generation part 304, an invoking part 305, and a movement control part 306. These functions may be implemented, for example, by a program installed in the secondary storage device 30A being loaded into the memory device 30B and executed by the CPU 30C. Also, the language model LM1 may be provided outside the excavator 100.

The language model LM1 may be a large language model (LLM). The language model LM1 may be implemented in an external device (for example, a server device) that is connected to the excavator 100 via the communication device 60 such that they can communicate with each other. The language model LM1 may be, for example, GPT-4.

The command acquiring part 301 may acquire a command related to the movement of the excavator 100 (hereinafter simply “command”), which is input from the operator in natural language.

A command that is received as an input from the operator may be accepted through the input device 52 installed in the cabin 10 in case the operator is operating the excavator 100 from the cabin 10, or accepted through the input device 207 of the remote operation assisting device 200 in case the operator is operating the excavator 100 from a remote spot.

A command in natural language may be, for example, a command input by the operator's voice in natural language. In this case, the command acquiring part 301 can acquire text data corresponding to the command in natural language, by applying existing speech recognition technology based on the sound/voice input data received by the input device 52 or the input device 207.

Also, a command in natural language may be a command input in text by an operator using the input device 52 or the input device 207, whereby characters and letters can be input, such as a keyboard or a touch panel. In this case, the command acquiring part 301 can acquire the text data accepted by the input device 52 or the input device 207 as a command in natural language.

The object detection part 302 may detect objects subject to monitoring around the excavator 100 based on output of the image capturing device 40 and a ranging sensor. For example, the object detection part 302 may detect objects subject to monitoring from images captured by the image capturing devices 40 by optionally applying existing image processing or machine learning technologies such as semantic segmentation.

Objects that are subject to monitoring may include, for example, people such as workers. Furthermore, objects that are subject to monitoring may include other obstacles around the excavator 100. These other obstacles may include, for example, specific moving objects at the work site of the excavator 100, such as other work machines and work vehicles. Also, other obstacles may include specific stationary objects at the work site of the excavator 100, such as utility poles, fences, and colored traffic or road cones (also referred to as “color cones” (registered trademark)). Furthermore, other obstacles may include specific topographical shapes at the work site of the excavator 100, such as ditches, holes, and piles of earth and sand.

The verbalization part 303 may verbalize the environment surrounding the excavator 100, using natural language. The verbalization part 303 may also verbalize the working drawing, which shows the target object that the excavator 100 is to work on, using natural language.

The verbalization part 303 may verbalize, for example, the positioning of objects that are subject to monitoring and detected by the object detection part 302 near the excavator 100, using natural language. To be more specific, the verbalization part 303 may verbalize the types and positions of objects that are subject to monitoring and detected by the object detection part 302 by applying their data to a predefined text template showing the positioning of objects subject to monitoring around the excavator 100. The same may apply to the verbalization of the arrangement of objects in the working drawing, which will be described later.

A text template showing the positioning of an object that is subject to monitoring may use “xxx” as the object's location information and “yyy” as the object's type or name. The template may be specified in the form of, for example, “yyy is at xxx.”, “yyy is located at xxx.”, and the like.

For example, as shown in FIG. 7, a person P, triangular traffic cones CN1 and CN2, and a pile of earth and sand PL may be detected by the object detection part 302 in front of the excavator 100.

In this example, the area around the excavator 100 may be divided into a front range RF, a rear range RB, a left range RL, and a right range, with the excavator 100 as the point of reference. Also, the front range RF may be divided into: a nearby range RF1 on the left front; a nearby range RF2 on the right front; a range RF3 on the left front and farther than the range RF1; and a range RF4 on the right front and farther than the range RF2, with the excavator 100 as the point of reference. Hereinafter, the range RF1, the range RF2, the range RF3, and the range RF4 will be verbalized as the “left front close range,” the “right front close range,” the “left front far range,” and the “right front far range,” respectively.

In this case, the person P is in the range RF1, so the verbalization part 303 may verbalize the presence of this person P as: “There is a person in the left front close range.” Also, the two triangular traffic cones CN1 and CN2 are included in range the RF2, so the verbalization part 303 may verbalize the presence of these triangular traffic cones CN1 and CN2 as: “There are two colored traffic cones in the right front close range.” Also, a pile of earth and sand PL is included in range the RF3, so the verbalization part 303 verbalizes the presence of this pile of earth and sand PL as: “There is a pile of earth and sand in the left front far range.”

Also, the verbalization part 303 may verbalize the presence of the person P, the triangular traffic cones CN1 and CN2, and the pile of earth and sand PL, by using distances and coordinates based on the excavator 100, as in the case of objects illustrated in the working drawing, which will be described later.

Also, the verbalization part 303 may verbalize, for example, the positioning of objects illustrated in the working drawing, by using natural language, with the position of the excavator 100 as the point of reference.

For example, there is a buried pipe in the working drawing, and the verbalization part 303 may verbalize this as: “There is a pipe 1 meter underground, 5 meters ahead.” Also, a utility pole is illustrated in the working drawing, and the verbalization part 303 may verbalize its presence as: “There is a utility pole 5 meters ahead and 2 meters to the right.” The verbalization part 303 may also verbalize the positions of objects illustrated in the working drawing using a coordinate system that is based on the excavator 100 or applied to the work site on a fixed basis.

The prompt generation part 304 may generate a prompt to be input to the language model LM1 based on the command in natural language acquired by the command acquiring part 301 and the information verbalized by the verbalization part 303. To be more specific, the prompt generation part 304 may generate a prompt based on the information about the surrounding environment of the excavator 100 and the working drawing, which is verbalized by the verbalization part 303, information for the excavator 100, so that control corresponding to the command acquired by the command acquiring part 301, is output.

For example, the prompt generation part 304 may generate multiple exercises and assign them to the language model LM1 in advance via the invoking part 305. An exercise may be defined by combining: information about the surrounding environment of the excavator 100 and the working drawing as a prerequisite (that is, a limitation); commands in the exercise; and the correct answer to be output. By this means, the language model LM1 can understand (learn) the output format for the commands in the prompt.

For example, as shown in FIG. 8, multiple exercises may be given. Each exercise can be expressed by combining information about the surrounding environment of the excavator 100, a command from the user (that is, the operator), and control information (control command) for the excavator 100. By this means, as shown in FIG. 9, the language model LM1 can output a control command corresponding to the movement of the excavator 100 in response to the prompt generated by the prompt generation part 304, that is, a command from the operator based on the surrounding environment of the excavator 100. Also, if a command cannot be understood, another command may be given to ask to repeat the command again, thereby preventing or substantially preventing the excavator 100 from moving inappropriately. The number of exercises to be given needs not be fixed; it is preferable if the number of exercises is greater than the types of control commands that correspond to the actions to be performed by the excavator 100. This is because the language model LM1 can understand all control commands.

The invoking part 305 may invoke the language model LM1 through, for example, a predetermined application programming interface (API), input the prompt generated by the prompt generation part 304 to the language model LM1, and obtain the output (answer).

The movement control part 306 may control the movement of the excavator 100 based on the output of the language model LM1 acquired by the invoking part 305. To be more specific, the movement control part 306 may drive the hydraulic actuators HA of the excavator 100 in accordance with the control command output from the language model LM1, and output a control command for controlling the movement of the excavator 100 to the hydraulic control valve 31.

Thus, according to this example, the controller 30 may control the movement of the excavator 100 based on results of having the language model LM1 interpret the operator's commands in natural language and the surrounding environment of the excavator 100 verbalized in natural language. By this means, the controller 30 can control the movement of the excavator 100 in accordance with the operator's commands in natural language that match the surrounding environment of the excavator 100.

In addition, some or all of the command acquiring part 301, the object detection part 302, the verbalization part 303, the prompt generation part 304, the invoking part 305, and the movement control part 306 may be provided in an information processing device outside the excavator 100. For example, when the excavator 100 is operated remotely, the command acquiring part 301, the object detection part 302, the verbalization part 303, the prompt generation part 304, the invoking part 305, and the movement control part 306 may be provided in the remote operation assisting device 200.

### [First Example Process for Assisting Excavator's Operation]

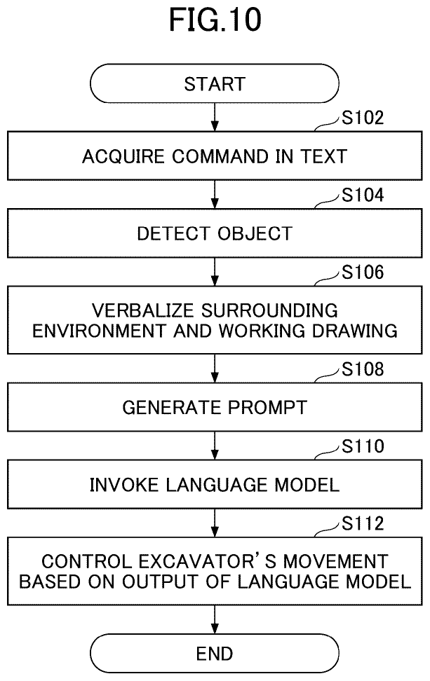

Next, referring to FIG. 10, a first example process for assisting the operation of the excavator 100 will be described.

FIG. 10 is a flowchart showing an overview of the first example process for assisting the operation of the excavator 100. This example may presume the functional structure of FIG. 6, which is for assisting the operation of the excavator 100.

The flowchart of FIG. 10 may be, for example, carried out when an operator's command in natural language is received as an input through the input device 52 or the input device 207.

As shown in FIG. 10, in step S102, the command acquiring part 301 may acquire a command in text.

When the process of step S102 is completed, the controller 30 may proceed to step S104.

In step S104, the object detection part 302 may detect objects subject to monitoring around the excavator 100, based on outputs of the image capturing devices 40 and the distance measurement sensor.

When the process of step S104 is completed, the controller 30 may proceed to step S106.

In step S106, the verbalization part 303 may verbalize the surrounding environment of and the working drawing for the excavator 100 in natural language.

When the process of step S106 is completed, the controller 30 may proceed to step S108.

In step S108, the prompt generation part 304 may generate a prompt to be input to the language model LM1 based on the results of the processing in steps S104 and S106.

When the process of step S108 is completed, the controller 30 may proceed to step S110.

In step S110, the invoking part 305 may invoke the language model LM1 and input the prompt generated in step S108.

When step S110 is completed and an output from the language model LM1 is obtained, the controller 30 may proceed to step S112.

In step S112, the movement control part 306 may control the movement of the excavator 100 based on the output of the language model LM1, that is, based on a control command.

When the process of step S112 is completed, the controller 30 may end the procedures of this flowchart.

### [Second Example Functional Structure for Assisting Excavator's Operation]

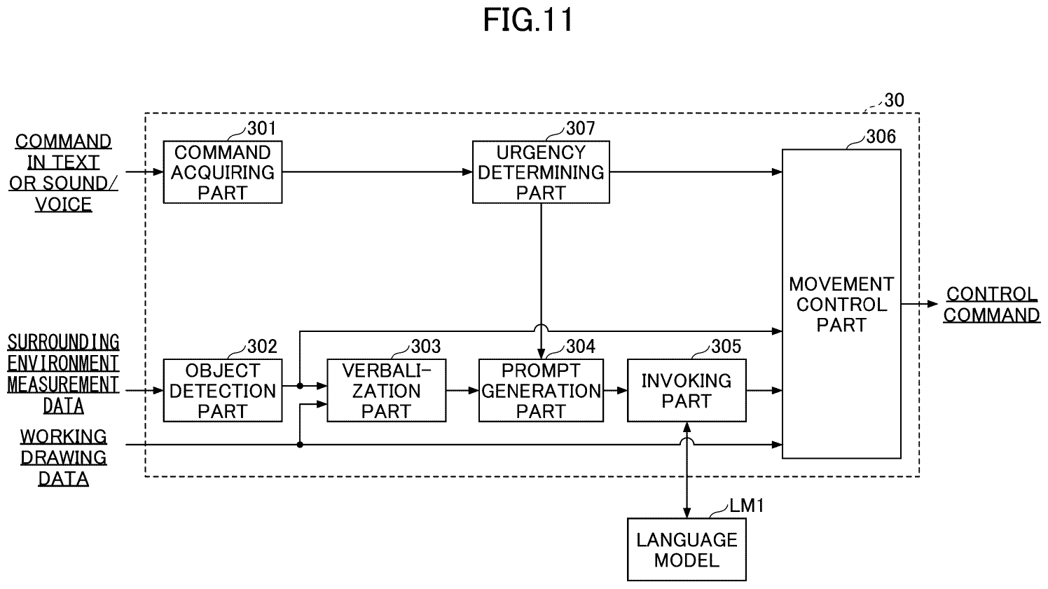

Next, referring to FIG. 11, in addition to FIG. 1 to FIG. 5, a second example functional structure for assisting the operation of the excavator 100 will be described.

In the following description, the same reference numerals will be used to designate parts that are the same or substantially the same as those of the first example functional structure described above, and therefore the following description will focus on differences from the first example functional structure described above.

FIG. 11 is a functional block diagram showing a second example functional structure for assisting the operation of the excavator 100.

As shown in FIG. 11, the controller 30 may include, as its functional parts, a command acquiring part 301, an object detection part 302, a verbalization part 303, a prompt generation part 304, an invoking part 305, and a movement control part 306, similar to the above-described first example. Also, unlike the above-described first example, the controller 30 may include an urgency determining part 307. These functions may be implemented, for example, when programs installed in the secondary storage device 30A are loaded into the memory device 30B and executed by the CPU 30C.

When the command acquiring part 301 may acquire a command, the urgency determining part 307 determines the urgency of the command. A command's urgency refers to the degree of urgency with which the excavator 100 needs to perform the operation that the command designates.

For example, the urgency determining part 307 may determine whether the urgency is high or low depending on whether or not a specific character sequence (hereinafter also referred to as a “critical word,” for ease of explanation) is included in the text acquired by the command acquiring part 301. Examples of critical words may include, for example, “danger,” “risky,” “stop,” and so forth. In this case, if a critical word is included in text acquired by the command acquiring part 301, the urgency determining part 307 may determine that the urgency is high; otherwise, the urgency determining part 307 may determine that the urgency is low.

When the urgency determining part 307 determines that the urgency is high, the urgency determining part 307 may send a notice that indicates that the urgency is high, to the movement control part 306, with the text of the command acquired by the command acquiring part 301.

When the movement control part 306 receives a notice of high urgency from the urgency determining part 307, the movement control part 306 may control the excavator 100 to make a predetermined movement (hereinafter, for ease of explanation, “urgent movement”) that corresponds to the command determined to be urgent. An urgent movement may be, for example, an operation to force the excavator 100 to a sudden stop (hereinafter referred to as “emergency stop operation”). Also, in addition to the emergency stop operation of the excavator 100, an urgent movement may include an operation to avoid danger by deliberately continuing the operation of the excavator 100 (hereinafter referred to as “danger avoidance operation”). In this case, the movement control part 306 determines whether to perform an emergency stop operation or a danger avoidance operation based on the words contained in the command's text.

On the other hand, if the urgency determining part 307 determines that the urgency of a given command is low, the urgency determining part 307 sends a notice that indicates that the urgency is low, to the prompt generation part 304, with the text of the command acquired by the command acquiring part 301.

The prompt generation part 304 generates a prompt to be input to the language model LM1 based on the natural language command acquired by the command acquiring part 301 and the information verbalized by the verbalization part 303, which are input via the urgency determining part 307.

The invoking part 305 invokes the language model LM1, inputs the prompt generated by the prompt generation part 304 to the language model LM1, and obtains the output (answer).

If the urgency determining part 307 determines that the urgency is low, the movement control part 306 may control the movement of the excavator 100 based on the output of the language model LM1 obtained by the invoking part 305, as in the above-described first example.

Thus, according to this example, when the urgency of a command from the operator is relatively high, the controller 30 does not use the language model LM1, and directly controls the excavator 100 to perform an urgent movement that the command designates. By this means, when the urgency of a command from the operator is high, the controller 30 can avoid delays caused by the use of the language model LM1 and control the excavator 100 to perform the corresponding urgent movement quickly.

In addition, some or all of the command acquiring part 301, object detection part 302, verbalization part 303, prompt generation part 304, invoking part 305, movement control part 306, and urgency determining part 307 may be provided in an information processing device outside the excavator 100. For example, when the excavator 100 is operated remotely, the command acquiring part 301, object detection part 302, verbalization part 303, prompt generation part 304, invoking part 305, movement control part 306, and urgency determining part 307 may be provided in the remote operation assisting device 200.

### [Second Example Process for Assisting Excavator's Operation]

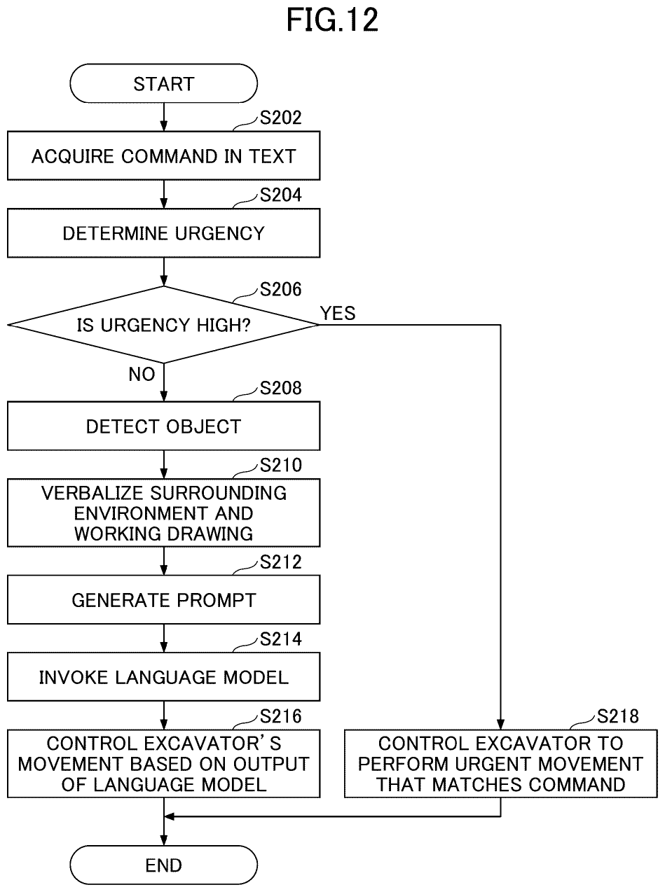

Next, referring to FIG. 12, a second example process for assisting the operation of the excavator 100 will be described.

FIG. 12 is a flowchart showing an overview of the first example process for assisting the operation of the excavator 100. This example presumes the functional structure for assisting the operation of the excavator 100 illustrated in FIG. 11.

The flowchart of FIG. 12 may be carried out, for example, when the operator's command written in natural language is received as an input through the input device 52 or the input device 207.

As shown in FIG. 12, the process of step S202 is the same as the process of step S102 in FIG. 10, and so its description will be omitted.

When the process of step S202 is completed, the controller 30 may proceed to step S204.

In step S204, the urgency determining part 307 may determine whether the command's urgency is relatively high or low, based on the text of the command acquired in step S202.

When the process of step S204 is completed, the controller 30 may proceed to step S206.

In step S206, the controller 30 may determine whether the urgency of the command acquired in step S202 is relatively high based on the result of step S204. If the urgency of the command is relatively low, the controller 30 may proceed to step S208. If the urgency of the command is relatively high, the controller 30 may proceed to step S218.

The processes of steps S208, S210, S212, S214, and S216 are the same as the processes of steps S104, S106, S108, S110, and S112 in FIG. 10 described above, and therefore will not be described here.

Meanwhile, in step S218, the movement control part 306 may control the excavator 100 to perform the urgent movement that the command acquired in step S202 designates.

When the process of step S216 or step S218 is completed, the controller 30 may end the procedures of this flowchart.

### [Third Example Functional Structure for Assisting Excavator's Operation]

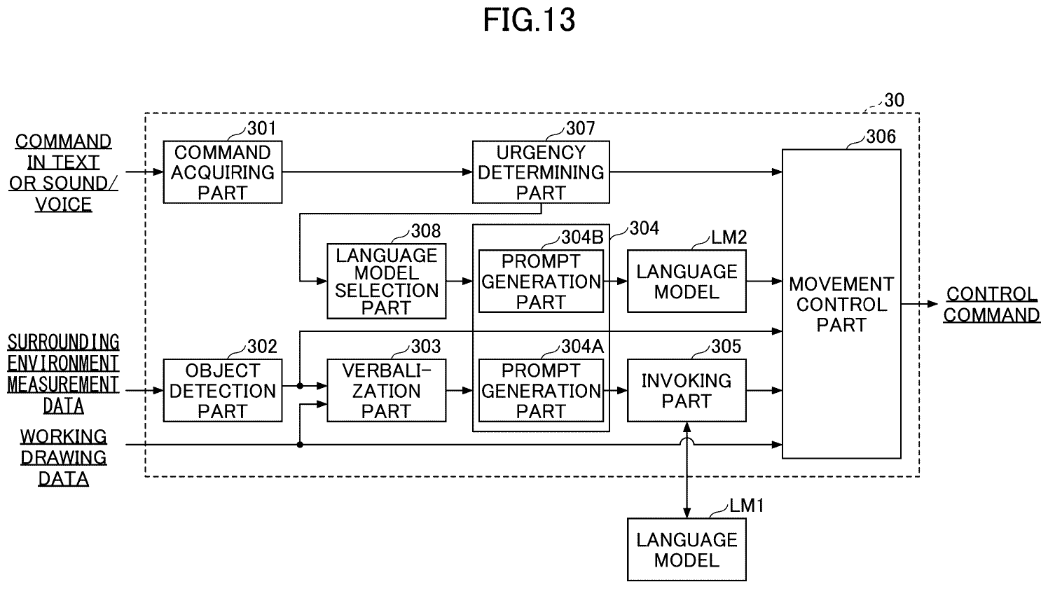

Next, referring to FIG. 13, in addition to FIG. 1 to FIG. 5, a third example functional structure for assisting the operation of the excavator 100 will be described.

In the following description, the same reference numerals will be used to designate parts that are the same or substantially the same as those of the first example functional structure and the second example described above, and therefore the following description will focus on parts that are different from the first example functional structure and the second example described above.

FIG. 13 is a functional block diagram showing a third example functional structure for assisting the operation of the excavator 100.

As shown in FIG. 13, the controller 30 may include, as its functional parts, a command acquiring part 301, an object detection part 302, a verbalization part 303, a prompt generation part 304, an invoking part 305, a movement control part 306, and an urgency determining part 307, as in the second example described above. Also, unlike the first example and second example described above, the controller 30 may include a language model LM2 and a language model selection part 308. These functions may be implemented, for example, by loading programs installed in the secondary storage device 30A into the memory device 30B and executing them on the CPU 30C.

The language model LM2 may be a language model that is relatively small with respect to the language model LM1.

The language model LM1 may be implemented in an information processing device that is provided apart from the controller 30 and is mounted on the excavator 100.

When the urgency determining part 307 determines that the urgency of a given command is low, the urgency determining part 307 may output a notice to the effect that the urgency is low, to the language model selection part 308, with the text of the command acquired by the command acquiring part 301.

When the urgency determining part 307 determines that the urgency of a given command from the operator is low, the language model selection part 308 may select whether the text of the command acquired by the command acquiring part 301 should be input to the language model LM1 or to the language model LM2. To be more specific, the language model selection part 308 may select the language model LM2 when the content of a command acquired by the command acquiring part 301 is relatively simple, and select the language model LM1 when the content of a command is relatively complex or difficult to understand.

For example, the language model selection part 308 may select one of the language models LM1 and LM2 based on the length of the text of the command acquired by the command acquiring part 301. The length of a command's text may be determined based on, for example, the number of characters or words in the text. To be more specific, the language model selection part 308 may select the language model LM1 if the length of the text of a command is relatively long with respect to a predetermined criterion, and select the language model LM2 otherwise. The text length being relatively long with respect to a predetermined criterion may mean that the text length is longer than or equal to the predetermined criterion, or that the text length is longer than the predetermined criterion.

Also, the language model selection part 308 may select one of the language models LM1 and LM2 based on the rarity of words included in the command text acquired by the command acquiring part 301. To be more specific, the language model selection part 308 may select the language model LM1 when the number of words with high rarity (hereinafter “rare among all words included in the command text is words”) relatively large compared to a predetermined criterion, and select the language model LM2 otherwise. Rare words are defined in advance. Using, for example, text matching technology, the language model selection part 308 may determine whether or not rare words are present and the number of rare words included in the command's text.

Also, the language model selection part 308 may select either the language model LM1 or LM2, taking into account both the length of the command's text and the rarity of the words contained in the text. In this case, the first condition that the length of the command's text is relatively long compared to a predetermined criterion, and the second condition that the number of rare words contained in the command's text is relatively large compared a predetermined criterion are applied. The language model selection part 308 may select the language model LM1 when both conditions are met, or select the language model LM1 when one of the conditions is met.

The language model selection part 308 may output the text of the command acquired by the command acquiring part 301, and information indicating the selected one of the language models LM1 and LM2, to the prompt generation part 304.

The prompt generation part 304 may generate a prompt to be input to the language model LM1 or the language model LM2. The prompt generation part 304 may include prompt generation parts 304A and 304B.

When the language model LM1 is selected by the language model selection part 308, the prompt generation part 304A may generate a prompt to be input to the language model LM1 based on the command acquired by the command acquiring part 301 and the information verbalized by the verbalization part 303.

When the language model LM2 is selected by the language model selection part 308, the prompt generation part 304B may generate a prompt to be input to the language model LM2 based on the command acquired by the command acquiring part 301 and the information verbalized by the verbalization part 303. The format of the prompt to be input to the language model LM2 may be the same as that for the language model LM1, or may be different.

The prompt generation part 304 may output the prompt generated by the prompt generation part 304A to the invoking part 305, and output the prompt generated by the prompt generation part 304B to the language model LM2.

The language model LM2 may receive as input the prompt from the prompt generation part 304B, and output control information (control command) for the excavator 100, similar to the language model LM1.

When the movement control part 306 receives the notice from the urgency determining part 307 to the effect that the urgency is high, the movement control part 306 may control the excavator 100 to perform the urgent movement that the command designates, similar to the second example described above.

Also, when the output of the language model LM1 is input from the invoking part 305, the movement control part 306 may control the movement of the excavator 100 based on the output of the language model LM1, as in the above-described first example.

Also, when the movement control part 306 receives the output from the language model LM2, the movement control part 306 may control the movement of the excavator 100 based on control information (control command) corresponding to the output of the language model LM2.

In this way, according to this example, the controller 30 can use the language models LM1 and LM2 depending on the content of the operator's command. Therefore, for example, when the operator's command is relatively simple, the language model LM2 can be used, and communication costs can be reduced compared to when the language model LM1 is used. Also, when costs are incurred for using the language model LM1, the cost of using the language model LM1 can be reduced. On the other hand, when the operator's command is relatively difficult or complex, the language model LM1 can be used, so that the accuracy of interpretation of control commands can be ensured. Therefore, according to this example, the controller 30 can achieve both prevention or substantial prevention of variable costs and more accurate movement of the excavator 100 in response to commands that arrive from the operator in natural language.

In addition, the command acquiring part 301, the object detection part 302, the verbalization part 303, the prompt generation part 304, the invoking part 305, the movement control part 306, the urgency determining part 307, the language model selection part 308, and the language model LM2 may be partly or entirely placed in an information processing device outside the excavator 100. For example, when the excavator 100 is operated remotely, the command acquiring part 301, the object detection part 302, the verbalization part 303, the prompt generation part 304, the invoking part 305, the movement control part 306, the urgency determining part 307, the language model selection part 308, and the language model LM2 may be provided in the remote operation assisting device 200.

### [Third Example Process for Assisting Excavator's Operation]

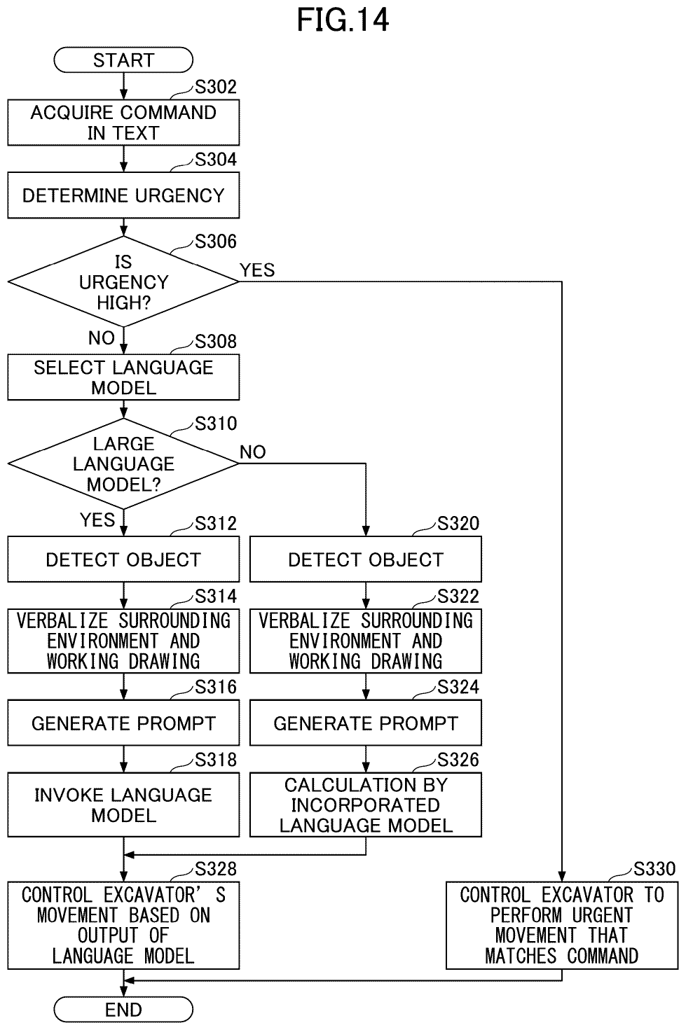

Next, referring to FIG. 14, a third example process for assisting the operation of the excavator 100 will be described.

FIG. 14 is a flowchart showing an overview of a third example process for assisting the operation of the excavator 100. This example presumes the functional structure for assisting the operation of the excavator 100 illustrated in FIG. 13.

The flowchart of FIG. 14 may be carried out, for example, when the operator's command written in natural language is received as an input through the input device 52 or the input device 207.

As shown in FIG. 14, the processes of steps S302, S304, and S306 are the same as steps S202, S204, and S206 in FIG. 12 described above, and so their description will be omitted.

In step S306, if the urgency of the command is relatively low, the controller 30 may proceed to step S308. If the urgency of the command is relatively high, the controller 30 may proceed to step S330.

In step S308, the language model selection part 308 may select one of the language models LM1 and LM2 based on the content of the text of the command acquired in the processing of step S302.

When the process of step S308 is completed, the controller 30 may proceed to step S310.

In step S310, the controller 30 may determine whether the language model LM1, which is relatively large, has been selected based on the result of step S308. If the language model LM1 has been selected, the process may proceed to step S312. If the language model LM2 has been selected, the process may proceed to step S320.

The processes of steps S312 and S314 are the same as the processes of steps S104 and S106 in FIG. 10 and steps S208 and S210 in FIG. 12 described above, and so their description will be omitted.

When the process of step S314 is completed, the controller 30 may proceed to step S316.

In step S316, the prompt generation part 304A may generate a prompt to be input to the language model LM1 based on the results of the processes of steps S312 and S314.

When the process of step S316 is completed, the controller 30 may proceed to step S318.

The process of step S318 is the same as step S110 in FIG. 10 and step S214 in FIG. 12 described above, and so its description will be omitted.

When the process of step S318 is completed and the output from the language model LM1 is obtained, the controller 30 may proceed to step S328.

Also, the processes of steps S320 and S322 are the same as the processes of steps S104 and S106 in FIG. 10 and steps S208 and S210 in FIG. 12 described above, and so their description will be omitted.

When the process of step S322 is completed, the controller 30 may proceed to step S324.

In step S324, the prompt generation part 304B may generate a prompt to be input to the language model LM2 based on the results of the processes of steps S320 and S322.

When the process of step S324 is completed, the controller 30 may proceed to step S326.

In step S326, the language model LM2 built in the controller 30 performs calculations using the prompt generated in step S324 as an input, and outputs control information (control command) for the excavator 100.

When the process of step S326 is completed, the controller 30 may proceed to step S328.

In step S328, the movement control part 306 may control the movement of the excavator 100 based on the output of the language model LM1 or the output of the language model LM2.

When the process of step S328 is completed, the controller 30 may end the procedures of this flowchart.

On the other hand, the process of step S330 is the same as the process of step S218 in FIG. 12 described above, and so its description will be omitted.

When the process of step S330 is completed, the controller 30 may end the procedures of this flowchart.

### [Fourth Example Functional Structure for Assisting Excavator's Operation]

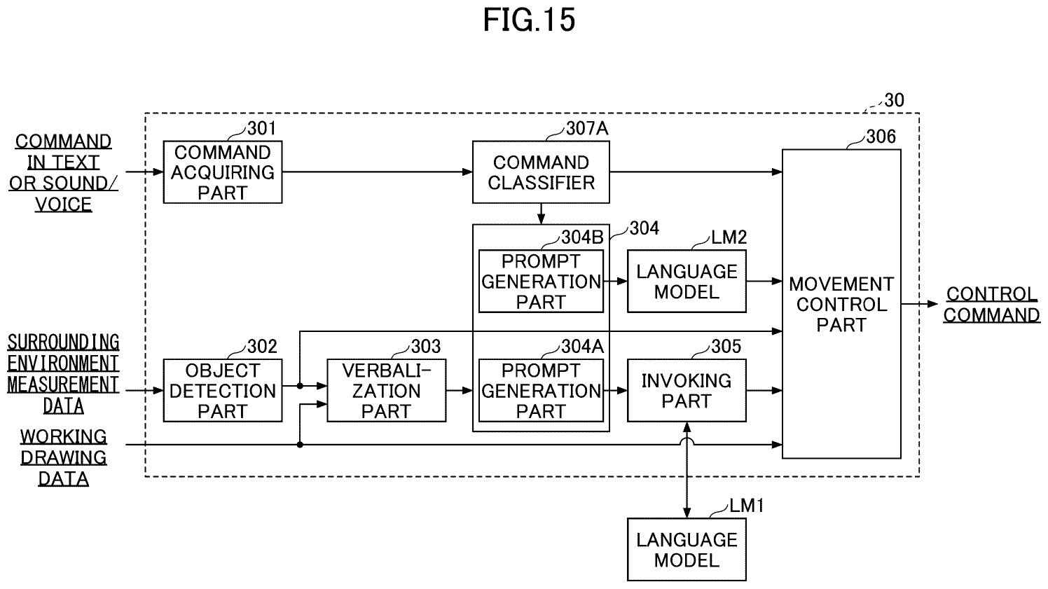

Next, referring to FIG. 15 in addition to FIG. 1 to FIG. 5, a fourth example functional structure for assisting the operation of the excavator 100 will be described.

In the following description, the same reference numerals are used to designate parts that are the same or substantially the same as those of the first to third example functional structures described above, and therefore the following description will focus on differences from the first to third example functional structures described above.

FIG. 15 is a functional block diagram showing a fourth example functional structure for assisting the operation of the excavator 100.

As shown in FIG. 15, this example is different from the third example functional structure described above in that a command classifier 307A is provided in the controller 30 instead of the urgency determining part 307 and the language model selection part 308.

The command classifier 307A may classify the commands acquired by the command acquiring part 301 as different types of commands, namely the first command, the second command, and the third command.

The first command is a command with a relatively high urgency. The second command is a command with a relatively low urgency and is relatively difficult or complex. The third command is a command with a relatively low urgency and is relatively simple.

In other words, the command classifier 307A may implement the functions of the above-described urgency determining part 307 and language model selection part 308 as a single 3-class classifier.

The command classifier 307A may be, for example, a trained model obtained by supervised learning. A trained model may be, for example, mainly composed of a neural network, and obtained by optimizing a base model using an error propagation algorithm based on the error between the inference result and the training data. A trained model may also be mainly composed of a support vector machine.

When the command classifier 307A classifies a command acquired by the command acquiring part 301 as a first command, the command classifier 307A may output to the movement control part 306 the text of the command acquired by the command acquiring part 301 and a notice to the effect that the command is a first command.

When movement control part 306 receives a notice from the command classifier 307A that the command acquired by the command acquiring part 301 is a first command, it controls the excavator 100 to perform an urgent movement that the command designates.

Also, when the command classifier 307A classifies the command acquired by the command acquiring part 301 as a second command or a third command, the command classifier 307A may output, to the prompt generation part 304, the text of the command acquired by the command acquiring part 301 and a notice to the effect that the command is a second command or a third command.

When the prompt generation part 304A receives a notice from the command classifier 307A that the command is the second command, the prompt generation part 304A may generate a prompt to be input to the language model LM1 based on the command acquired by the command acquiring part 301 and the information verbalized by the verbalization part 303.

When the prompt generation part 304B receives a notice from the command classifier 307A to the effect that the command is the third command, the prompt generation part 304A may generate a prompt to be input to the language model LM2 based on the command acquired by the command acquiring part 301 and the information verbalized by the verbalization part 303.

In this way, according to this example, the controller 30 can incorporate the functions of the urgency determining part 307 and the language model selection part 308 into the command classifier 307A, which is substantially equivalent to a 3-class classifier.

In addition, some or all of the command acquiring part 301, the object detection part 302, the verbalization part 303, the prompt generation part 304, the invoking part 305, the movement control part 306, the command classifier 307A, and the language model LM2 may be provided in an information processing device outside the excavator 100. For example, when the excavator 100 is operated remotely, the command acquiring part 301, the object detection part 302, the verbalization part 303, the prompt generation part 304, the invoking part 305, the movement control part 306, the command classifier 307A, and the language model LM2 may be provided in the remote operation assisting device 200.

### [Fourth Example Process for Assisting Excavator's Operation]

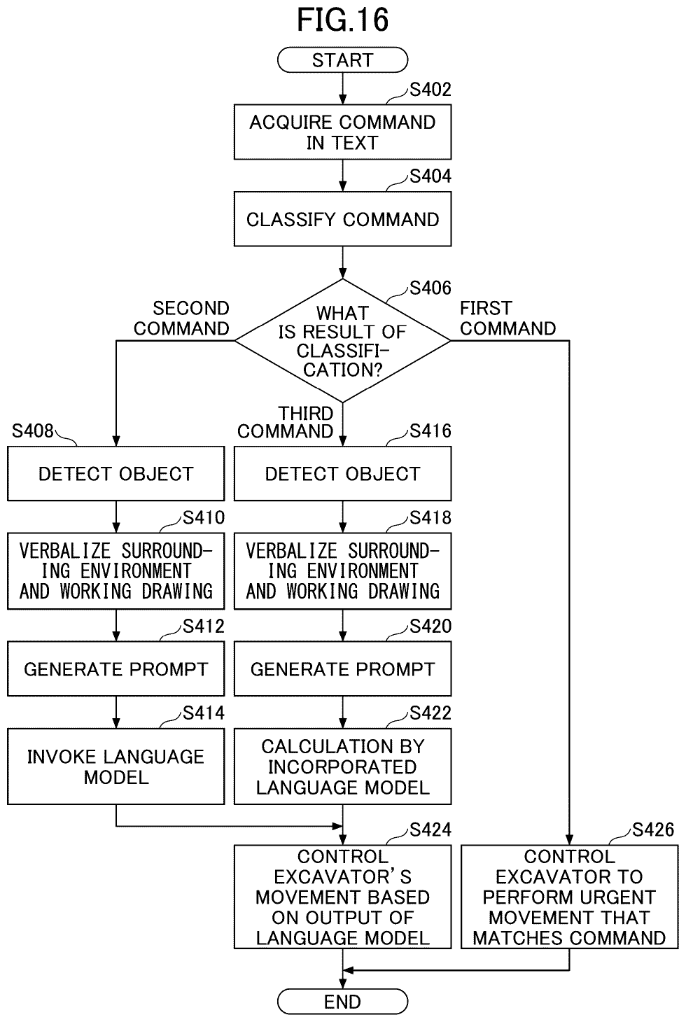

Next, referring to FIG. 16, a third example process for assisting the operation of the excavator 100 will be described.

FIG. 16 is a flowchart showing an overview of a fourth example process for assisting the operation of the excavator 100. This example may be based on the functional structure for assisting the operation of the excavator 100 illustrated in FIG. 15.

The flowchart of FIG. 16 may be carried out, for example, when the operator's command written in natural language is received as an input through the input device 52 or the input device 207.

As shown in FIG. 16, the process of step S402 is the same as the process of step S102 in FIG. 10 described above, and so its description will be omitted.

When the process of step S402 is completed, the controller 30 may proceed to step S404.

In step S404, the command classifier 307A may classify the command acquired in step S402 as one of the first command, the second command, or the third command.

When the process of step S404 is completed, the controller 30 may proceed to step S406.

In step S406, the controller 30 may determine whether the result of the classification in step S404 is the first command, the second command, or the third command. If the result of the classification is the second command, the controller 30 may proceed to step S408. If the result of the classification is the third command, the controller 30 may proceed to step S416. If the result is the first command, the controller 30 may proceed to step S426.

The processes of steps S408, S410, S412, and S414 are the same as the processes of steps S312, S314, S316, and S318 in FIG. 14 described above, and therefore will not be described here.

When the process of step S414 is completed, the controller 30 may proceed to step S424.

Also, the processes of steps S416, S418, S420, and S422 are the same as the processes of steps S320, S322, S324, and S326 in FIG. 14 described above, and therefore will not be described.

When the process of step S422 is completed, the controller 30 may proceed to step S424.

The process of step S424 is the same as the process of step S328 in FIG. 14 described above, and so its description will be omitted.

When the process of step S424 is completed, the controller 30 may end the procedures of this flowchart.

The process of step S426 is the same as the process of step S330 in FIG. 14 described above, and so its description will be omitted.

When the process of step S426 is completed, the controller 30 may end the procedures of this flowchart.

### [Fifth Example Functional Structure for Assisting Excavator's Operation]

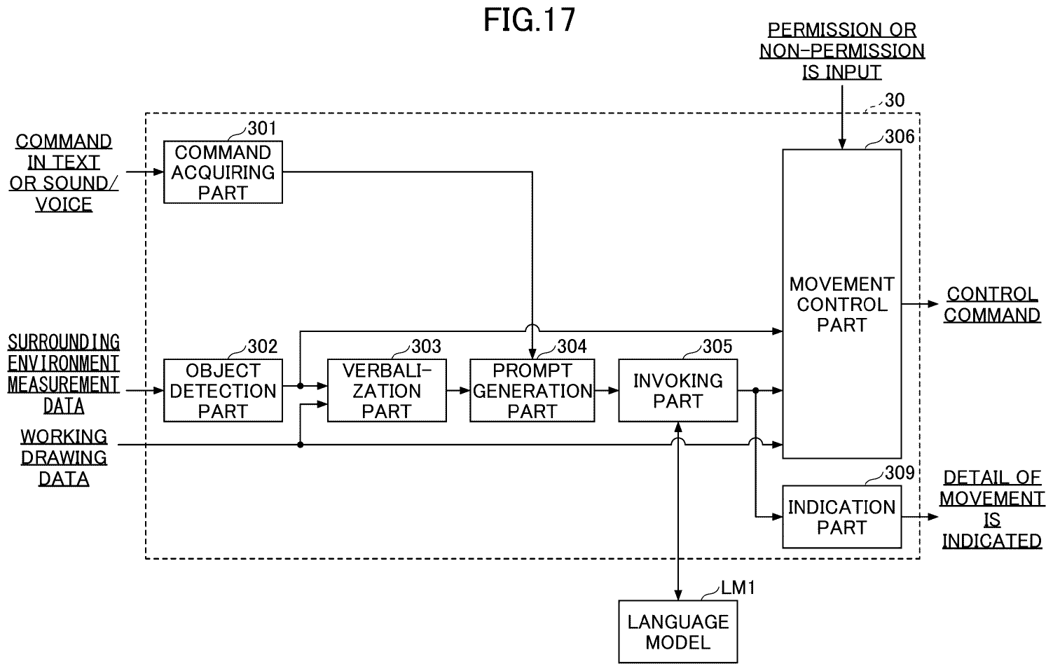

Next, referring to FIG. 17 in addition to FIG. 1 to FIG. 5, the fifth example functional structure for assisting the operation of the excavator 100 will be described.

In the following description, the same reference numerals are used to designate parts that are the same or substantially the same as those of those in the above-described first example functional structure to the fourth example functional structure, and therefore the following description will focus on differences from the above-described first example functional structure to the fourth example functional structure.

FIG. 17 is a functional block diagram showing a fifth example functional structure for assisting the operation of the excavator 100.

As shown in FIG. 17, the controller 30 may include a command acquiring part 301, an object detection part 302, a verbalization part 303, a prompt generation part 304, an invoking part 305, and a movement control part 306, similar to the above-described first example. Also, unlike the above-described first example, the controller 30 may include an indication part 309.

As shown in FIG. 17, the controller 30 may include a command acquiring part 301, an object detection part 302, a verbalization part 303, a prompt generation part 304, an invoking part 305, and a movement control part 306, similar to the above-described first example. Also, unlike the above-described first example, the controller 30 may include an indication part 309.

Also, the indication part 309 may notify the operator of information about the procedures of the job of the excavator 100 for that day, together with the details of operation scheduled for the excavator 100. By this means, the operator can check whether the details of the movement of the excavator 100 scheduled by his/her voice or text input command conforms to the job procedures of the excavator 100 scheduled for that day.

When the movement control part 306 receives an input indicating permission to move, from the operator via the input device 52 or the input device 207 after a notice is sent from the indication part 309, the movement control part 306 may control the movement of the excavator 100 based on the output of the language model LM1.

On the other hand, when the movement control part 306 receives an input indicating disallowance of movement from the operator via the input device 52 or the input device 207 after a notice is sent from the indication part 309, the movement control part 306 may stop controlling the movement of the excavator 100 based on the output of the language model LM1. The same is also true in the case where, after a notice is sent from the indication part 309, there is neither an input permitting movement nor an input not allowing movement from the operator.

Thus, according to this example, the controller 30 can implement movement of the excavator 100 based on a command in natural language from the operator, with the operator's prior confirmation and permission of the details of the movement of the excavator 100. Therefore, the controller 30 can prevent or substantially prevent inappropriate operations of the excavator 100 and improve the safety of the excavator 100.

### [Fifth Example Process Assisting Excavator's Operation]

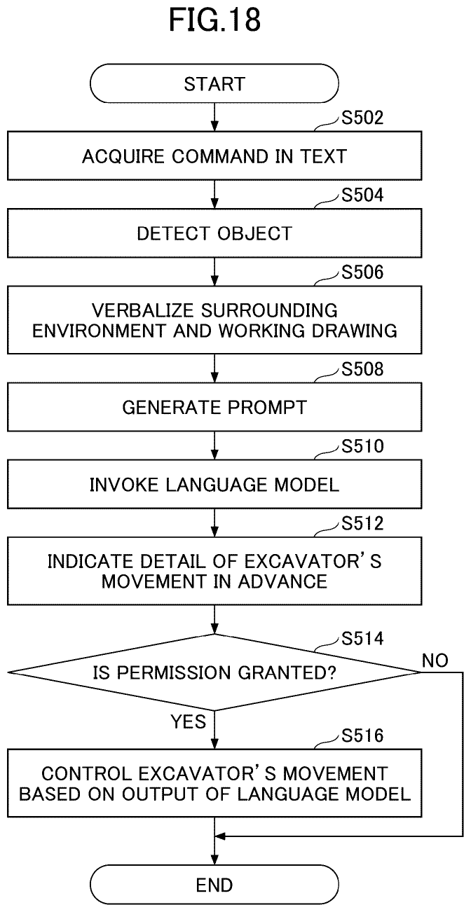

Next, referring to FIG. 18, a fifth example process related to the operation assistance of the excavator 100 will be described.

The flowchart of FIG. 18 is carried out when a command in natural language from the operator is received as an input through the input device 52 or the input device 207, for example.

As shown in FIG. 18, the processes of steps S502, S504, S506, S508, and S510 are the same as the processes of steps S102, S104, S106, S108, and S110 in FIG. 10 described above, and therefore a description thereof will be omitted.

When the process of step S510: completed, the controller 30 may proceed to step S512.

In step S512, the indication part 309 notifies the operator, in advance, of the details of the movement of the excavator 100.

When the process of step S512 is completed, the controller 30 may proceed to step S514.

In step S514, the controller 30 may determine whether or not an input permitting movement has been received from the operator. If an input permitting movement is received from the operator within a specific period of time following the notice, the controller 30 may proceed to step S516; otherwise, the controller 30 may end the procedures of this flowchart.

The process of step S516 is the same as the process of step S112 in FIG. 10 described above, and so its description will be omitted.

When the process of step S516 is completed, the controller 30 may end the procedures of this flowchart.

### OTHER EMBODIMENTS

Next, other embodiments will be described.

The above-described embodiments may be combined, modified, or changed as appropriate.

For example, in the above-described third example functional structure, the urgency determining part 307 may be omitted. In this case, the language model selection part 308 selects either the language model LM1 or LM2 regardless of the urgency of the command acquired by the command acquiring part 301.

Also, in the above-mentioned second example functional first example functional structure to fourth example functional structure or examples of variations and modifications thereof, a function similar to that of the indication part 309 of the above-mentioned fifth example functional structure may be added. However, if the urgency of the command acquired by the command acquiring part 301 is determined to be relatively high, or if the command is classified as the above-mentioned first command, advanced notice about the details of operation need not be given to the operator.

In addition, the functional structure and the first to fifth examples related to the above-mentioned operation assistance and examples of their modifications and variations may be applied to work machines other than the excavator 100. Other work machines include, for example, bulldozers, mobile cranes, etc.

### [Advantages]

Next, advantages of the work machine, information processing device, and program according to the present disclosure will be described.

According to a first example of the present disclosure, a work machine may include an environment information acquiring part, a verbalization part, a command acquiring part, and a control part. The work machine may be, for example, the above-described excavator 100. The environment information acquiring part may be, for example, the above-described image capturing device 40. The verbalization part may be, for example, the above-described verbalization part 303. The command acquiring part may be, for example, the above-described command acquiring part 301. The control part may be, for example, the above-described movement control part 306. To be more specific, the environment information acquiring part may acquire information that represents the environment surrounding the work machine. Also, the verbalization part may verbalize the information acquired by the environment information acquiring part in natural language. Also, the command acquiring part may acquire a command from the work machine's operator in natural language. Also, the control part may control the movement of the work machine based on the interpretation of the command acquired by the command acquiring part and the information verbalized by the verbalization part by a language model. The language model may be, for example, the above-described language model LM1 or language model LM2.

Also, according to the first example of the present disclosure, an operation assisting system may include the environment information acquiring part, the verbalization part, the command acquiring part, and the control part. The operation assisting system may be, for example, a remote operation assisting system SYS.

Also, according to the first example of the present disclosure, an information processing device may include a verbalization part configured to verbalize information representing the environment surrounding the work machine in natural language, the command acquiring part, and the control part. The information processing device may be, for example, the above-described controller 30 or remote operation assisting device 200.

Also, according to the first example of the present disclosure, a non-transitory computer-readable recording medium may store instructions that, when executed by a computer, cause the computer to function as an information processing device and perform a method including a verbalization step, a command acquisition step, and a control step. To be more specific, in the verbalization step, information that represents the environment surrounding a work machine is verbalized in natural language. Also, in the command acquisition step, a command from the work machine's operator is acquired. Then, in the control step, the movement of the work machine is controlled based on the interpretation of the command acquired in the command acquisition step and the information verbalized in the verbalization step by a language model.

By this means, the operator can operate the work machine based on commands that match the environment surrounding the work machine and that are given in natural language. Consequently, the work machine, the operation assisting system, and the work machine, operation assisting system, and information processing device according to the present disclosure (hereinafter “the machine, system, and device according to the present disclosure”) can improve the effectiveness of their operations by the operator by using commands in natural language.

Also, according to a second example of the disclosure, based on the first example described above, the verbalization part may be further configured to verbalize information of a working drawing in natural language, in addition to the information acquired by the environment information acquiring part.

By this means, the operator can operate the work machine, for example, by using commands in natural language that match the content of a working drawing. Consequently, the machine, system, and device according to the present disclosure can improve the effectiveness of their operations by the operator of the work machine by using commands in natural language.

Also, according to a third example of the present disclosure, based on the above-described first or second example, the machine, system, and device according to the present disclosure may include a determining part that is configured to determine whether the urgency of the command acquired by the command acquiring part is high or low. The determining part may be, for example, the above-described urgency determining part 307. The control part may be further configured to: when the command is one of a high urgency, control the work machine to make a predetermined movement that conforms to the command; and, when the command is one of a low urgency, control the movement of the work machine based on the interpretation, given by the predetermined language model, of the command acquired by the command acquiring part and the information verbalized by the verbalization part.

By this means, the work machine can quickly perform an urgent movement when a command with a relatively high urgency arrives.

Also, according to a fourth example of the present disclosure, based on the above-described third example, the determining part may be further configured to determine that the command is one of the high urgency when a predetermined word that indicates the high urgency is included in text of the command acquired by the command acquiring part.

By this means, the machine, system, and device according to the present disclosure can appropriately determine the urgency of commands.

Also, according to a fifth example of the present disclosure, based on any one of the first to fourth examples described above, the language model may be a first language model or a second language model. The first language model may be relatively large and provided outside the work machine such that the first language model and the work machine are able to communicate with each other. The second language model may be relatively small and incorporated in the work machine. The first language model may be, for example, the above-described language model LM1. The second language model may be, for example, the above-described language model LM2. Also, the machine, system, and device according to the present disclosure may include a selection part that is configured to select the predetermined language model by selecting the first language model or the second language model based on the details of the command acquired by the command acquiring part. The selection part may be, for example, the above-described language model selection part 308. The control part may be further configured to control the movement of the work machine based on the interpretation, by the predetermined language model selected by the selection part, of the command acquired by the command acquiring part and the information verbalized by the verbalization part.

By this means, the machine, system, and device according to the present disclosure can use either the first language model or the second language model depending on the content of a command. Consequently, the machine, system, and device according to the present disclosure can reduce the cost of communication and the fees for using the first model, for example.

Also, according to a sixth example of the present disclosure, based on the above-described fifth example, the selection part may be further configured to select the predetermined language model between the first language model and the second language model based on at least one of the length of the command acquired by the command acquiring part or the rarity of a word included in the command.

By this means, the machine, system, and device according to the present disclosure can use the first language model wen the text of a command is relatively long or when the rarity of a word included in the command is relatively high, and use the second language model otherwise. Consequently, the machine, system, and device according to the present disclosure can reduce the cost of communication and the fees for using the first model while ensuring the appropriateness and accuracy of the work machine's operation in response to commands from the operator.

Also, according to a seventh example of the present disclosure, based on the first or second example described above, the language model may be a first language model or a second language model. The first language model may be relatively large and provided outside the work machine such that the first language model and the work machine are able to communicate with each other. The second language model may be relatively small and incorporated in the work machine. Furthermore, the machine, system, and device according to the present disclosure may further include a classifying part that is configured to classify the command acquired by the command acquiring part into: a first command for controlling the work machine to perform an urgent movement; a second command for controlling the work machine based on interpretation of the command given by a first language model; or a third command for controlling the work machine based on interpretation of the command given by a second language model. The classifier may be, for example, the above-described command classifier 307A. The control part may then control the operation of the work machine in accordance with the command acquired by the command acquiring part, based on the result of classification in the classifier.

By this means, the machine, system, and device according to the present disclosure can implement the functions of the determining part and selection part described above, with a classifier that is equivalent to one 3-class classifier.

Also, according to an eighth example of the present disclosure, based on any one of the first to sixth examples described above, the machine, system, and device according to the present disclosure may include an indication part that is configured to send an indication in advance, to the operator of the work machine, about the movement of the work machine under control of the control part, when the command is acquired by the command acquiring part. Then, when permission is given by the operator of the work machine upon the sending of the indication, the control part may control the movement of the work machine based on the interpretation, given by the predetermined language model, of the command acquired by the command acquiring part and the information verbalized by the verbalization part.

By this means, the work machine can have the operator confirm in advance the details of the excavator's movement based on the content of a command, and, under the assumption that permission is obtained, the work machine can perform operations based on the operator's command. Consequently, the machine, system, and device according to the present disclosure can prevent or substantially prevent inappropriate operation of the work machine and improve the safety of the work machine.

Although embodiments of the present disclosure have been described in detail above, the present disclosure is not limited to such specific embodiments, and various modifications and changes can be made within the scope of the gist recited in the accompanying claims.

What is claimed is:

1. A work machine comprising:
an environment information acquiring part configured to acquire information about an environment surrounding the work machine;
a verbalization part configured to verbalize the information acquired by the environment information acquiring part in natural language;
a command acquiring part configured to acquire a command from an operator of the work machine in natural language; and
a control part configured to control movement of the work machine based on interpretation of the command acquired by the command acquiring part and the information verbalized by the verbalization part, the interpretation being given by a predetermined language model.

2. The work machine according to claim 1, wherein the verbalization part is further configured to verbalize information of a working drawing in natural language, in addition to the information acquired by the environment information acquiring part.

3. The work machine according to claim 1, further comprising a determining part configured to determine whether an urgency of the command acquired by the command acquiring part is high or low,
wherein the control part is further configured to:
when the determining part determines that the command is one of a high urgency, control the work machine to make a predetermined movement that conforms to the command; and
when the determining part determines that the command is one of a low urgency, control the movement of the work machine based on the interpretation, given by the predetermined language model, of the command acquired by the command acquiring part and the information verbalized by the verbalization part.

4. The work machine according to claim 3, wherein the determining part is further configured to determine that the command is one of the high urgency when a predetermined word that indicates the high urgency is included in text of the command acquired by the command acquiring part.

5. The work machine according to claim 1, further comprising a selection part configured to select the predetermined language model by selecting a first language model or a second language model, based on details of the command acquired by the command acquiring part,
wherein the first language model is relatively large and provided outside the work machine such that the first language model and the work machine are able to communicate with each other, and the second language model is relatively small and incorporated in the work machine, and
wherein the control part is further configured to control the movement of the work machine based on interpretation, given by the predetermined language model selected by the selection part, of the command acquired by the command acquiring part and the information verbalized by the verbalization part.

6. The work machine according to claim 5, wherein the selection part is further configured to select the predetermined language model between the first language model and the second language model based on at least one of a length of the command acquired by the command acquiring part or a rarity of a word included in the command.

7. The work machine according to claim 1, further comprising a classifying part configured to classify the command acquired by the command acquiring part into:
a first command for controlling the work machine to perform an urgent movement;
a second command for controlling the work machine based on interpretation of the command given by a first language model; or
a third command for controlling the work machine based on interpretation of the command given by a second language model,
wherein the first language model is relatively large and provided outside the work machine such that the first language model and the work machine are able to communicate with each other, and the second language model is relatively small and incorporated in the work machine, and
wherein the control part is further configured to control the movement of the work machine based on the command acquired by the command acquiring part based on a result of classification by the classifying part.

8. The work machine according to claim 1, further comprising an indication part configured to send an indication in advance, to the operator of the work machine, about the movement of the work machine under control of the control part, when the command is acquired by the command acquiring part,
wherein, when permission is given by the operator of the work machine upon the sending of the indication, the control part controls the movement of the work machine based on the interpretation, given by the predetermined language model, of the command acquired by the command acquiring part and the information verbalized by the verbalization part.

9. An operation assisting system comprising:
an environment information acquiring part configured to acquire information about an environment surrounding the work machine;
a verbalization part configured to verbalize the information acquired by the environment information acquiring part in natural language;
a command acquiring part configured to acquire a command from an operator of the work machine in natural language; and
a control part configured to control movement of the work machine based on interpretation of the command acquired by the command acquiring part and the information verbalized by the verbalization part, by a predetermined language model.

10. An information processing device comprising:
a verbalization part configured to verbalize information about an environment surrounding a work machine in natural language;
a command acquiring part configured to acquire a command from an operator of the work machine in natural language; and
a control part configured to control movement of the work machine based on interpretation of the command acquired by the command acquiring part and the information verbalized by the verbalization part, the interpretation being given by a predetermined language model.

11. A non-transitory computer-readable recording medium storing instructions that, when executed by a computer, cause the computer to operate as the work machine of claim 1.
